(19) United States
(12) Patent Application Publication
(10) Pub. No.: US 2018/0285546 A1
(43) Pub. Date: Oct. 4, 2018

(54) TOKEN

(71) Applicant: Robert Greenberg, Honolulu, HI (US)

(72) Inventor: Robert Greenberg, Honolulu, HI (US)

(21) Appl. No.: 15/943,315

(22) Filed: Apr. 2, 2018

Related U.S. Application Data
(60) Provisional application No. 62/480,530, filed on Apr. 2, 2017.

(51) Int. Cl. G06F 21/34; H04L 9/32; H04L 9/06

(52) U.S. Cl. CPC G06F 21/34; H04L 9/3226; H04L 9/0643; H04L 9/0662; H04L 9/3297

(57) ABSTRACT

The invention provides a token configured to show a time-dependent code produced by an algorithm, e.g. a pseudorandom code produce by a hash-based algorithm. A token of the invention optionally has a large character size of the shown code, a short code, a long code update interval, and/or a wall mount. The invention also provides a system of a token and a server running a validation algorithm that uses the same code-time correlation and can receive an input comprising a historical token-produced code or time and return the corresponding time or code, respectively. Tokens and systems of the invention are optionally useful to provide site visit verification which allow a first user to record a code from a token mounted at a desired site, and a second user to, at a later time, determine when the code was produced, thereby verifying that the first user visited the site at a given time.

### TECHNICAL FIELD

The present invention relates tokens for providing a one-time code (OTC).

### BACKGROUND

One-time password generators have been widely used in industry for many years. The use of one-time passwords for access to sensitive information eliminates both the need for a user to remember complex passwords and overcomes the issue of user tendency to use the same password for multiple accounts and never change passwords. Often times, one-time passwords are used in conjunction with multiuse passwords (i.e. multifactor authentication). One time passwords rely a user and an authenticating server that both have access to the same sequence of one-time passwords.

In a token based approach, a company may provide a token to the user as part of an authentication process for accessing online accounts. A token is a device or software that contains a sequence generator. A sequence generator is an algorithm that generates a pseudorandom sequence of characters (typically 6 to 8 digits). The sequence generator uses the current time or value to compute the next value.

A server maintains the same pseudorandom sequence generator as the token. Each value remains valid for a short time period, typically one minute or a few minutes. The instantly-generated pseudorandom sequence prevents someone else from obtaining authorization without the token. In real time, the server will verify that the pseudorandom sequence entered by the user (shown on the token) matches the current value in the sequence determined by the server. Human error is not a problem in these real time systems because, if a user misreads or mistypes the code, the server immediately identifies this error and the user merely has to retype the code.

In a historically unrelated field, site visit verification is a broad term for the act of confirming a person is at a real or virtual site. However, one strategy of site visit verification has been used that implements the use of tokens. Specifically, a token is given to an at-home healthcare patient and a then caregiver is required, once the caregiver is in the presence of the patient, to call the caregiver's administrator and read the instantaneous code from the patient's token to the administrator. The administrator verifies that the token code corresponds to the instantaneous code produced on the server end and verifies that the patient has received care by the scheduled time. As with prior OTP tokens, this system uses a minute-by-minute six digit code to verify instantaneous password matching with the server in real time. In other words, this system operates in real time the same a traditional OTP system, except a user calls in a code (rather than entering on a website) and a telephone operator acts as the code-matching server.

What is missing in the art is a token that reduces token-interaction time and eliminates human error in viewing and recording. Such a token would be especially useful for scenarios in which a token code is recorded by the user for verification at a later time.

### SUMMARY OF THE INVENTION

In one aspect, the invention provides a token configured to show a code (e.g. pseudorandom time-dependent code) produced by an algorithm. The token comprises a display, a non-transitory storage medium comprising the algorithm, and a controller configured to run the algorithm and cause the display to show the code. A token of the invention optionally has one or more of the following characteristics:
a. a large character size of the shown code;
b. a short code;
c. a long code update interval; and
d. a wall mount.

Optionally the code is 2-5 characters (e.g. 3-4 characters).

Optionally the code update interval is at least 4 hours (e.g. at least 12 or 24 hours).

Optionally, the character size of the shown code has a height of at least 0.7 cm.

Optionally, the token is configured to show a first code produced by a first algorithm and a second code produced by a second algorithm, wherein the first algorithm and the second algorithm produce codes based on different time-code correlations (e.g. use different secret keys). Optionally, the first code and the second code comprise the same number of characters. Optionally, the first algorithm and the second algorithm use the same update interval length (e.g. 24 hours). Optionally the update intervals of the first and second algorithm reset at the same time (i.e. the codes are updated at the same time, e.g. at midnight).

In another aspect, the invention comprises a system comprising the token and a server. The server runs a validation algorithm that uses the same correlation of the time and code value as the algorithm that is stored on the token. The server is optionally configured to prompt a server user (e.g. locally or over a network) to input a code or time and run the validation algorithm to output to the user the time or code corresponding to the input time or code, respectively. The server is useful, for example, to allow a user to correlate token-produced codes with respective times at which the codes were produced by the token. Servers of the invention are, for example, especially useful for retroactive correlation of token codes and times (i.e. later verification of historical codes).

Embodiments of the invention, e.g. having a large character size and/or short code, reduce token/user interaction time and surprisingly eliminate human error in viewing and recording codes. Such a token is surprisingly useful for scenarios in which a token code is recorded by the user for verification (e.g. determination of code production time) at a later time at which it would be impossible to correct a human error of misreading or misrecording the token-displayed code. Thus tokens of the invention are surprisingly useful for situations in which human error must be absent for a system to function correctly.

### BRIEF DESCRIPTION OF THE DRAWINGS

FIG. 1A depicts a token of the invention. FIG. 1B depicts the display of the token.

FIGS. 2A-2D depict different display states of a token of the invention.

FIGS. 3A and 3B depict a token of the invention which shows two codes.

FIG. 4 depicts a system of the invention comprising a network.

FIG. 5 depicts a system of the invention comprising a network.

FIG. 6 depicts a system of the invention comprising a network.

FIG. 7 depicts a system of the invention comprising a network.

FIG. 8 depicts a system of the invention comprising a network.

FIG. 9 depicts components of a token of the invention.

FIG. 10 depicts steps of a token algorithm useful in a token of the invention.

FIG. 11 depicts steps of a token algorithm useful in a token of the invention.

FIG. 12 depicts a system of the invention comprising a network.

FIG. 13 depicts steps of a validation module useful in a system of the invention.

FIG. 14 depicts steps of a synchronization module useful in a system of the invention.

FIG. 15 depicts a database of variables that can be referenced by a validation algorithm in a system of the invention.

FIG. 16 depicts a code-recording sheet with codes recorded from a token (“Employee filled code sheet”) and a Validation Code sheet with codes produced by a validation module.

### DETAILED DESCRIPTION OF THE INVENTION

### Overview

The invention provides tokens, systems, methods for using the systems, and non-transitory computer readable media (sometimes referred to simply as ‘memory’) that causes a controller to carry out a method of the invention.

Tokens of the invention produce a time-dependent code. Specifically, a token comprises an algorithm that uses a unique correlation of time and code value (e.g. to produce a sequence of pseudorandom codes wherein the code value updates depending on the passing of time). The algorithm is optionally configured to update the code value upon the elapse of a specified update interval (e.g. 24 hours, 12 hours, or 1 minute). Optional tokens of the invention large displays to show codes with a large character size, short codes, and wall mounts.

A system of the invention comprises a token and a server configured to validate codes produced by a token. The server runs a validation module that uses a validation algorithm which correlates time and code value using the same time-code correlation used by the token algorithm (e.g. the same secret key of a hash). Rather than use the current time as a time input into the validation algorithm, the server receives (or outputs) a historical time, i.e. the value of a previous time that has already occurred. The validation module is either configured to receive an input of time and output the corresponding code, or receive an input of code an output the corresponding time.

A system of the invention can optionally be used to perform site visit verification. Specifically, a token can optionally by positioned at a site which a person is required to inspect, wherein the user records a code displayed by the token. At a later time, a verifying person (e.g. an employer) can optionally use the validation module to correlate token-produced codes with the times at which the token produced them. Thus, the verifying person will know if and when the token user visited the token (and its associated site). The associated site may optionally be a security checkpoint, an alarm panel, or a video monitor that personnel are required to visit, for example, periodically.

A method of the invention comprises steps of causing a computer to perform functions of a module taught herein. For example, the invention contemplates a method of causing a computer to function as a validation module, a synchronization module, or a registration module.

A non-transitory computer readable memory of the invention comprises instructions for causing a computer to perform a method of the invention.

Another non-transitory computer readable memory of the invention comprises instructions for causing a token controller to perform functions taught herein (e.g. run a token algorithm, display a code produced from the algorithm, control a display based on user operation of a user interface, or display information at determined locations)

### Token Controller

A token of the invention comprises a controller configured at least to run an algorithm stored on a non-transitory storage medium and control the display.

The controller can be a single, independently-operating controller or a plurality of controllers operating in combination, for example a first controller configured to run the algorithm and a second controller configured to control the display.

Examples of useful controllers include central processing units such as general purpose microprocessors, special purpose microprocessors, a combination of general and special purpose microprocessors, instruction set processors, and/or related chips sets.

A controller can be “configured” to perform functions, for example, by providing, on a non-transitory storage medium, instructions that, when read by the controller, cause the controller to perform the functions. Examples of useful non-transitory storage media include firmware, non-volatile memory such as read-only memory, volatile memory, flash memory, or any other suitable optical, magnetic, or solid-state computer readable media, as well as a combination thereof.

Clock

A controller of the invention is configured to obtain a clock signal (e.g. a clock time or signal indicative of clock time), for example, from a clock comprised by the token (e.g. a hardware clock such as a quartz clock).

The controller obtains the clock signal and uses the clock signal (or data based on the clock signal) as a variable to run the token algorithm. The controller can optionally be configured to produce from the clock signal, a time, e.g. a local time, world time, or timer time (e.g. a timer starting from 0, sequentially updating the number upon the elapse of a predetermined amount of time).

During manufacture, the clock time can be synchronized with the clock on a server (e.g. NTP server), for example, to allow clock drift to be determined at a later date.

While nearly all clocks experience some degree of drift (i.e. error) over time, this drift has not presented a problem in prior art OTP tokens for real-time verification because the drift is immediately recognized by the validating server when user logs in with their token password (e.g. based on the recognizing a password that is one iteration forward or backward), and the validating server can simply shift its own time to match that of the drifted token clock. However, in some embodiments, the present invention is specifically designed to provide the user with a code that is recorded and validated later. Thus, real time synchronization of server and token clocks may not be possible and user on the validating end must trust that the token clock was correct. Accordingly, the clock is optionally an accurate clock that experiences less than 3 minutes of drift per year.

Code Algorithm

A controller of the invention is configured to produce a code by running an algorithm. The value of the code that is produced is dependent upon a specific correlation between time value and code value. The code algorithm can be configured to produce a different code each time a predetermined period of time elapses (‘update interval’). For example, the code can be dependent on the number of times the predetermined time interval has elapsed since an initiation time. The algorithm is optionally any algorithm that uses the clock in order to regularly increment the code value to a new value. Additionally or alternatively, the algorithm is optionally a function that receives a time (e.g. local time, world time, or timer time) and produces a new code as an output. Additionally or alternatively, the algorithm is optionally a function that receives a previous code as an input (equation variable) and produces a new code as an output (e.g. where the equation is run each time the update interval elapses). As such, whether using the time as an input or a previous code (which was produced based on the elapse of time) or the iteration number of the previous code, the new code is dependent on the time at which the algorithm was run. Thus, while any given code can appear random to the user, the sequence of codes is in fact very predictable (e.g. a pseudorandom code) if one knows the time-code correlation (e.g. knows the algorithm and secret key), and is optionally how it can be compared to the sequence of codes calculated by a verifying server. Accordingly, both the token of the invention and a server can optionally run the same algorithm or algorithm that use the same time-code correlation to produce the same code based on a given time input.

Optionally, the algorithm is configured such that, with a given algorithm and seed, the series of codes that will result is predicable, but to one without knowledge of the seed and/or algorithm the series of codes appear random.

Optionally, algorithm uses a secret key. The secret key is optionally combined with the time (or value that is based on or derived from the time) to input into an equation of the algorithm (e.g. a hash function). Thus, even for two secret key type algorithms that use the same equation, the secret key must be the same for the two algorithms to have the same time-code correlation because different secret keys will produce different codes from the same time input.

Optionally, the algorithm uses a hash function. For example, the algorithm can be a keyed-hash message authentication code (HMAC) algorithm such as a HOTP algorithm. Other examples of time-code correlations are well known in the art.

Code Update Interval

The code algorithm can optionally be configured to update (i.e. change) the code value after a defined period of time has elapsed. The defined period of time is hereby referred to the update interval.

Optionally, update interval is at least four hours, at least six hours, at least 8 hours, at least 12 hours or at least 24 hours.

Optionally, the update interval from 1 minute to 1 hour (e.g. 1 minute or 1 hour).

Optionally, update interval is from 4 hours to 48 hours.

Optionally, update interval is from 8 hours to 48 hours.

Optionally, update interval is from 12 hours to 48 hours.

Optionally, update interval is from 4 hours to 24 hours.

Optionally, update interval is from 8 hours to 24 hours.

Optionally, update interval is from 12 hours to 24 hours.

Optionally, the update interval is 1 minute.

Optionally, the update interval is 1 hour.

Optionally, the update interval is 2 hours.

Optionally, the update interval is 4 hours.

Optionally, the update interval is 6 hours.

Optionally, the update interval is 8 hours.

Optionally, the update interval is 1 day or 24 hours.

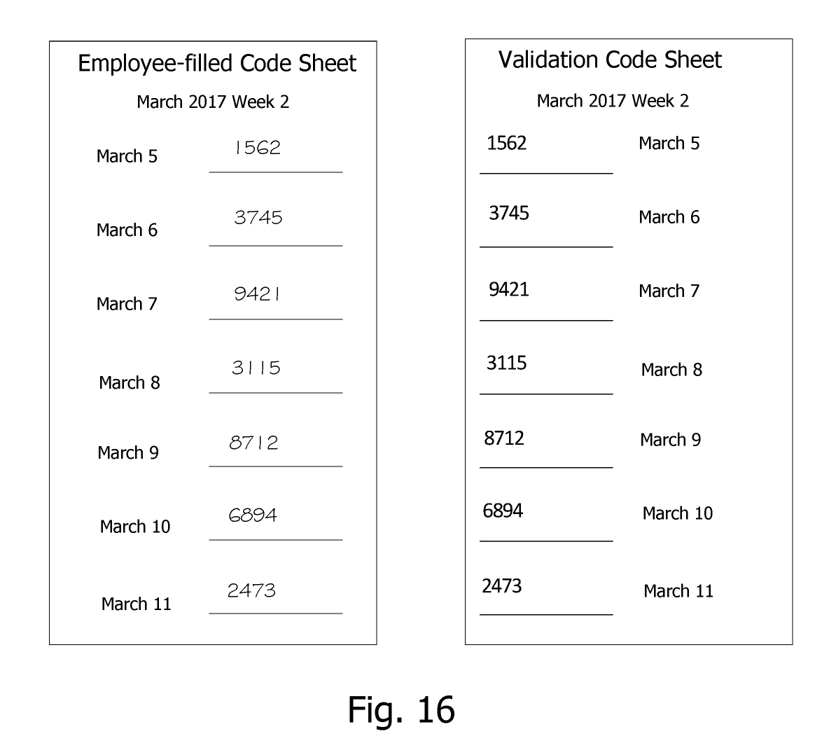

An update interval can optionally be any interval determined to be useful for verifying that a token (e.g. and real site in proximity to the token) is visited by a user within a desired window of time. For example, if an employer requires an employee to physically visit a real site (e.g. security checkpoint or alarm display panel) once in a window of time (e.g. once a day), the update interval can be selected to be 24 hours. In this illustrative example, each day, the employee optionally visits the site and nearby token and records (e.g. hand writes on a visit form as shown in FIG. 16) the code corresponding to the respective 24-hour period in which they visited the token. Then, for example, at the end of each month, the employer can produce (e.g. print) a list of codes for the month (e.g. in a format that allows physical alignment with the code sheet, e.g. as shown in FIG. 16) and verify that each code from the hand-filled visit form matches a code on the printed sheet.

Code Character Set

The code algorithm can optionally be configured to produce a code from a predefined character set. The character set can optionally be a numeric character set (e.g. having digits 0-9 as characters), an alphabetic character set (e.g. having letters A-Z as characters) an alphanumeric character set (e.g. having digits 0-9 and letters A-Z as characters), or hexadecimal character set (e.g. having digits 0-9 and letters A-F as characters).

The algorithm code algorithm can optionally be configured to produce a code from a predefined character set by independently selecting, for each character position of the code, a character from the character set.

Number of Code Characters

The code algorithm can optionally be configured to produce a code having a defined number of characters. The code can be formed from any number of characters. Optionally, the code is a short code. A short code is any code comprising 2-5 characters. Optionally, the code has 2, 3, 4 or 5 characters.

Tokens of the prior art are typically used to obtain real-time (i.e. instantaneous) feedback from a password-verifier or telephone operator to inform the user whether they have correctly read the code shown by a token. In these prior art tokens, a user can simply reread the code upon learning they have misread (or mis-recorded) the code. However, tokens of the invention showing short codes are surprisingly useful for recording (e.g. hand-writing by the user) and verifying the code at a later date. Accordingly, in this scenario, a user may not be immediately informed if they have misread the code and the use of a short code (e.g. in combination with a large character size) ensures that the user views and records the code without human error. Further, the invention is optionally implemented with a code that has a longer update interval (e.g. 24 hours). Unlike more rapidly updating codes, a longer update interval produces relatively less possibilities in a given time frame (e.g. a year) for codes and does not require a long code with many permutations (i.e. a large number of characters).

Number of Code-Producing Algorithms

Optionally, a token of the invention is configured to show a first code produced by a first algorithm and a second code produced by a second algorithm, wherein the first algorithm and the second algorithm produce codes based on different time-code correlations (e.g. use different secret keys).

The code algorithm can optionally be configured to produce a code having a defined number of characters.

Optionally, the first code and the second code comprise the same number of characters.

Optionally, the first algorithm and the second algorithm use the same update interval length, and optionally the update intervals reset at the same time (i.e. the codes are updated at the same time).

Optionally, the first code and the second code are displayed (e.g. asynchronously displayed such as with a wait time of at least 1 or 5 minutes between display of first and second codes) on different portions of the display (e.g. one is left justified and the other is right justified). This can reduce confusion to the user as to which code the user is viewing.

Optionally, a token configured to show a first code and a second code and the token comprises a first user interface (e.g. first button) configured to, when operated (e.g. pushed) display the first code and further comprises a second user interface (e.g. second button) configured to, when operated (e.g. pushed) display the second code. Providing different user interfaces to display the two codes reduces confusion to the user as to which code the user is viewing. Optionally, such a token comprises a third user interface (e.g. third button) that can be operated to show other information (e.g. date, time, or token ID).

Optionally, a token configured to show a first code and a second code does not show either code by default (e.g. without operating a user interface). Optionally, the token, after showing a code, returns the display to a state in which no code is displayed after a specified period of time (e.g. showing another type of information such as date or an information type that does not have the same number of characters as either code). This configuration different user interfaces to display the two codes reduces confusion to the user as to which code the user is viewing.

Optionally, a token configured to show a first code and a second code prevents showing the first code and the second code in the same specified period of time (e.g. 1 or 5 minutes). Optionally, a token configured to require a wait time (e.g. of at least 1 minute, at least 5 minutes, at least 30 minutes, at least an hour, or at least 4 hours) between display of the first code and the second code. These configurations prevent a user from obtaining both codes within the specified period of time. Multi-code tokens (e.g. two-code tokens) can be used to allow a person (e.g. employer) to designate a first code as an open or start code (e.g. inspection at start of the day at a site) a second code as an close or end code (e.g. inspection at end of the day at a site). Preventing both codes from being displayed to the user upon a single visit (i.e. within the specified period of time or wait time) ensures that the employee does not record both codes (which may optionally correspond to a long update interval such as 24 hours) in a single visit in an attempt to falsify a record of two visits, or use a short visit to falsify a record of a long visit.

Self-Destruction Feature

Optionally, a token of the invention is configured to destroy the code algorithm upon detection of tampering with the token (e.g. opening of a token housing and/or disconnecting the power source). Optionally, the algorithm or a time-code correlation used by the algorithm (e.g. secret key) is stored on volatile memory such that the memory is erased upon losing power.

Other Information for Display

Optionally the controller is configured to display information other than codes taught herein. Examples of said other information include the date, the time (e.g. local or world time), and token ID (e.g. serial number).

Optionally, the controller is configured to show the other information asynchronously (i.e. not at the same time) with the code(s).

Optionally, the controller is configured to asynchronously show the current time and a code on different portions of the display (e.g. one left justified and the other right justified).

Optionally, the controller is configured to show information other than time (e.g. the code or date) by default (e.g. reverting back to show the other information after a period of time), and the controller is configured to allow a user to operate a user interface (e.g. hold a button down, long press a button, double tap a button, or simultaneously push two buttons) to keep displaying the time (e.g. this is useful when a user is using a synchronization module and waiting for the time to change).

### Token Display

A token of the invention comprises a display that shows a code generated by a code algorithm.

The display can be any type of display that can show a code. For example, the display can be a liquid crystal display (LCD), a light emitting diode (LED) display, an organic light emitting diode (OLED) display, an electrophoretic (ePaper) display, or an electrochromic (EC) display.

A display of the invention optionally comprises a plurality of display elements (e.g. segments and/or dots) that can have their state changed (e.g. on/visible or off/invisible state), wherein the display shows each character of a code by providing a character-forming pattern of the display elements in a visible state, e.g. an off display element can optionally be turned on by sending a voltage through it such as a display element of an LCD display.

Optionally, the display comprises a plurality of independent groups of display elements, wherein each group of display elements can be independently modulated to show a character of the code.

Code Character Size

A token of the invention comprises a display that is configured to show a plurality of characters which form the code produced by the algorithm. While the shown characters can be any size, the display optionally shows the code at a large character size, for example, a character having a height of at least 0.6 cm.

Optionally, the character height of the shown code is at least 0.65 cm, at least 0.7 cm, at least 0.75 cm, at least 0.8 cm, at least 0.9 cm, or at least 0.95 cm, or at least 1 cm, or at least 1.1 cm (e.g. determined using height “H” shown in 1B.

Optionally, the character width of the shown code is at least 0.2 cm, at least 0.3 cm, at least 0.4 cm, at least 0.5 cm, at least 0.8 cm, or at least (e.g. determined using width “W” shown in 1B).

Optionally, the characters of the shown code have a height to width aspect ratio of at least 1 or at least 1.5.

Said character height is optionally the height of at least one shown character of the code. Alternatively, said character height is optionally the height of each shown character of the code. Alternatively, said character height is optionally the height of each shown character of the code that has a horizontal component at the top or bottom of the character (e.g. 0, 2, 3, 4, B, C, D, etc.), noting that the number 1 or I (when shown without a horizontal component) can optionally have a height slightly less than characters that have a horizontal component on top or bottom such as “0” or “8” (e.g. as is commonly seen on 7-segments LCDs).

Such large character sizes are particularly useful to allow error-free viewing of the code from a distance and/or in low lighting environments, even upon only a quick glance from the user. Tokens of the prior art are typically used to obtain real-time (i.e. instantaneous) feedback from a password-verifier or telephone operator to inform the user whether they have correctly read the code shown by a token. In these prior art tokens, a user can simply reread the code upon learning they have misread (or mis-recorded) the code. However, tokens of the invention are surprisingly useful for recording (e.g. hand-writing by the user) and verifying the code at a later date. Accordingly, in this scenario, a user may not be immediately informed if they have misread the code and the large character size (e.g. in combination with a short code) ensures that the user views and record the code without human error.

Number of Code Character Groups

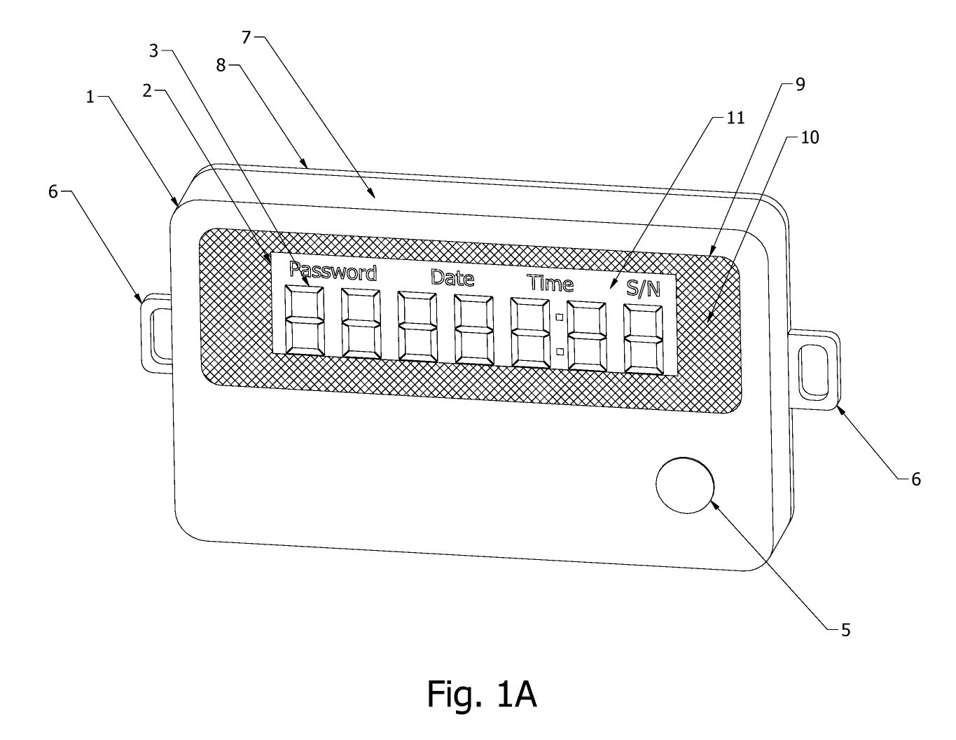

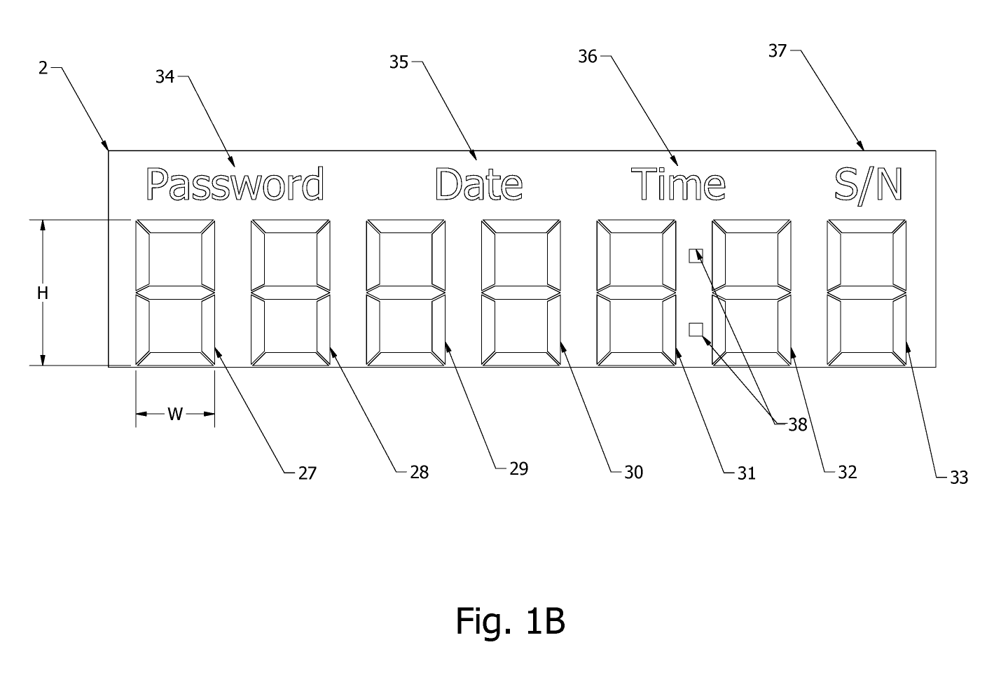

As taught herein, the display optionally comprises a plurality of independent groups of display elements (e.g. where each element is a segment or dot), wherein each group of display elements can be independently modulated to show a character of the code. In such an embodiment, the display comprises at least one group of display element for each character position of the code (e.g. groups 27, 28, 29, and 30 in FIG. 1B can each represent a different position). For example, if the code is made up of four characters, the display can comprise at least four independent groups of display elements.

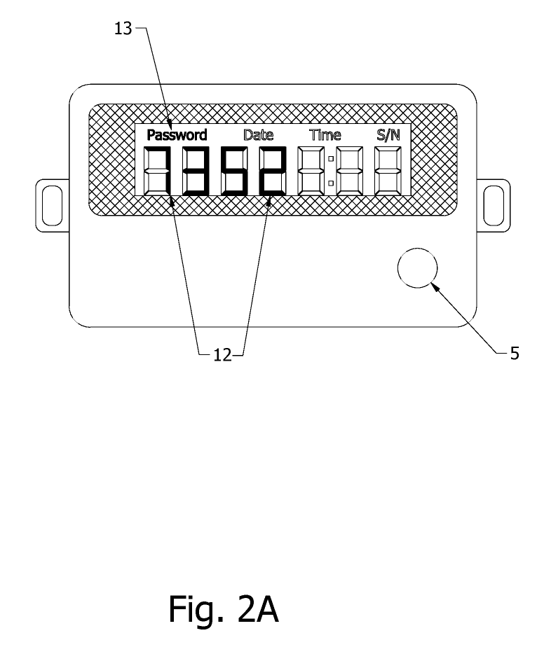

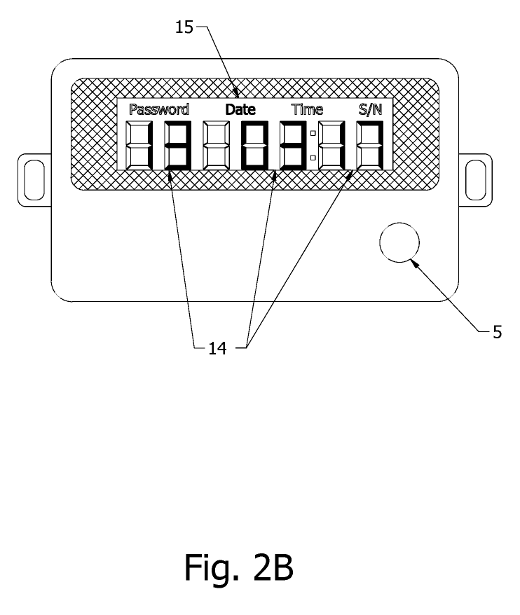

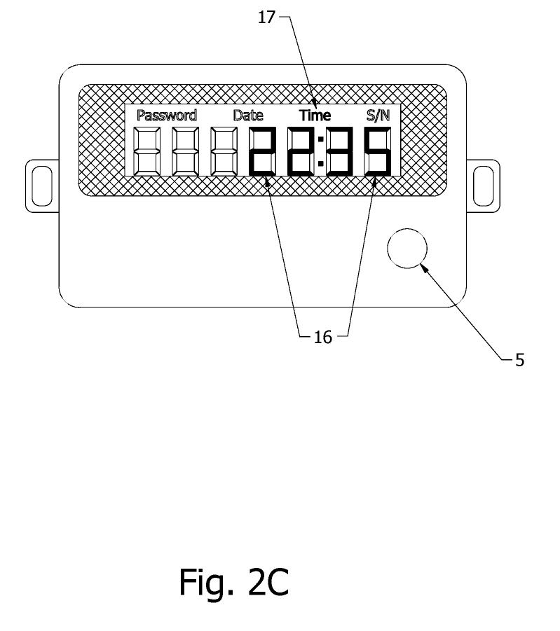

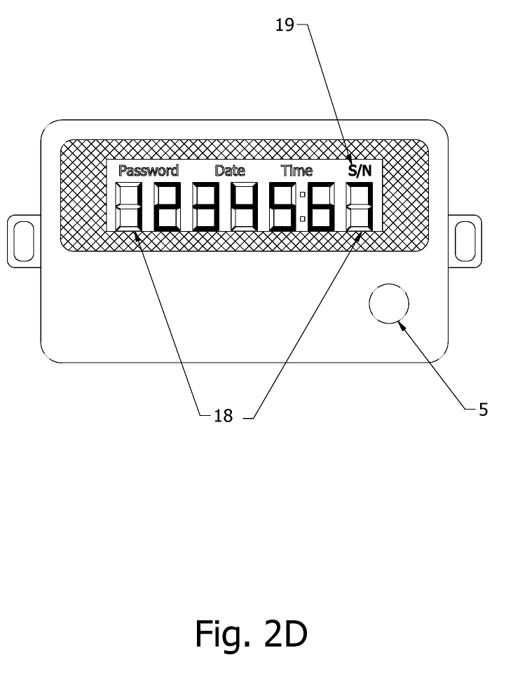

Optionally, the display comprises a number of display element groups that is greater than the number of characters of the code (e.g. FIG. 1B depicts seven groups 27-33, and the FIG. 2A shows the code only uses the first four groups).

Optionally, the display can show other information that requires a number of characters greater than the number of characters of the code. In such an embodiment, the display optionally shows said other information by modulating the same (or a portion of the) plurality of groups used to show the code while also modulating one or more of the additional display element groups. Additionally or alternatively, the display can show other information that is shown by modulating one or more groups other than the groups modulated to show the code.

Examples of said other information include the date, the time (e.g. local or world time), a serial number representative of the token hardware, and/or a second code, as depicted in FIGS. 2B-2D.

For example, the display can have a first number of display element groups (e.g. seven) by which the display can show information. If, for example, the code is four digits, the display can be configured to use four of the display element groups to show the code, and to use other display element groups (optionally in combination with the four display element groups) to display another information such as date or time. For example, the code can be shown using groups 1-4, while the date is shown using groups 1, 2, 4,5, 6, and 7, for example, using a first set of two adjacent groups (e.g. groups 1 and 2) to show a two-digit representation of the month, a second set of two adjacent groups (e.g. groups 4 and 5) to show a two-digit representation of the day of the month, and a third set of two adjacent groups (e.g. groups 4 and 5) to show a two-digit representation of the day of the year. As another example, the time can be shown using groups 4-7. Examples of such configurations are shown in FIGS. 2A-2D.

Optionally, the display is configured (via the controller) to show the at least two information types (e.g. a code and a time wherein the code and the time are shown using at least one non-shared group (i.e. one group not used by both information types), such as shown by comparing FIGS. 2A and 2C). Optionally, said two information types are shown asynchronously. The use of at least one non-shared group provides an indicator to the user of which type of information the user is viewing. For example, the code can be shown using groups 1-4 (e.g. where groups 1-4 are at the left of the display) of the while the time is shown using groups 4-7 (e.g. where groups 4-7 are at the right of the display).

Display Element Groups

Optionally, the display comprises a plurality of groups of display elements, wherein each group can be modulated to show a character of the code. The display elements of each group can be, for example, segments, dots, or a combination thereof. Optionally, a character of the code is shown by selectively turning each display element on or off according to the graphic pattern of the character.

Optionally, one or more (or each) group of the plurality of groups used to show the code is comprised (or consists of) 7-16 segments, for example, a 7-segment group, 9-segment group, a 14-segment group, or a 16-segment group. Other group types are well-known in the art of displays.

Optionally, the display comprises a plurality of additional groups of the same type (e.g. having the same shape, orientation, and/or number of display elements) as the groups used to show the code, for example, in-line (e.g. forming a row) with the groups used to show the code, e.g. as shown in FIG. 2A. Such additional groups can optionally be used, independently of the groups used to show the code, to show other information types. Additionally or alternatively, such additional groups can be used, in combination with one or more of the groups used to show the code, to show another information type (e.g. date, time, serial number), e.g. as depicted in FIGS. 2B-2D.

Optionally, the display comprises a plurality of additional display element groups or display elements of a different type (e.g. having a different same shape, orientation, and/or number of display elements) as the groups or elements used to show the code. For example, the display optionally comprises a set of two dots or segments between any two (e.g. between the third to last and the second to last) groups (e.g. groups as defined in the immediately preceding paragraph), for example, to provide a colon such as a colon used to separate the hour and minute in a shown time.

As another example of additional groups that can be provided, the display optionally comprises a display elements or a group of display elements having a non-standard shape (e.g. a shape other than a dot or straight bar segment) that can be modulated to show a pre-determined (e.g. and non-changeable) information type such as a label for any of the information types taught herein (e.g. a label of “code” or “password”, “date”, “time”, “and “serial” or “s/n”). Such non-standard shapes can optionally be provided in the shape of pre-formed letters or words which, as such, are non-changeable (but can be turned on and off) and used only to show the pre-formed letters or words at a designated time (e.g. show “time” when the time is shown by independently modulating a series of groups of the same type such as 7-segment groups).

Backlight

Optionally, a token of the invention comprises display backlight. The backlight can be configured in any manner that illuminate a display (e.g. passive display) to enable viewing in dark or low-lighting environments.

### Token Housing

A token of the invention optionally comprises a housing configured to at least partially surround and/or support one or more of the controller and the display and optionally other components of the token.

Optionally, the housing comprises a face plate and a backing plate. Optionally, the face plate and a backing plate are disconnectable (e.g. screwed together)

Window

Optionally, the housing comprises a window configured to cover the display. The window can be any transparent covering that allows viewing of the display there through.

Optionally, the window comprises an anti-glare configuration, e.g. a clear plastic covering over a display (e.g. glass display)

### Token Wall Mount

A token of the invention optionally comprises a wall mount or a mount configured to securing the token to any supportive structure. The token mount can be any structure that is configured to mount the token to a wall or another supportive structure.

Examples of useful mounts include one or more screw holes or eyelets, adhesive such as double-sided tape (e.g. having pressure-sensitive adhesive), hook and loop (e.g. Velcro) fastener, suction cup, magnet, or any fastener.

Optionally, the token comprises a first screw hole and a second screw hole on opposing sides (e.g. left and right or top and bottom) of the token.

Optionally, the token comprises one or more screw holes formed in (e.g. formed with by an extrusion process, casting process, or milling process) a backing plate of a housing of the token.

Optionally, the token is provided in a kit comprising a mount (e.g. double sided tape or eyelets) or component thereof (e.g. one or more screws for one or more eyelets). Optionally the kit comprises at least one one-way (or security) screw or fastener, for example, to prevent unauthorized dismounting and removal of the token. One-way screws and fasteners are devices which cannot be removed by conventional tools such as hex (or Allen) wrenches, Philips or flat head screw drivers, six or 12-sided socket wrenches, or torx wrench.

### Token User Interface

A token of the invention optionally comprises a user interface configured to accept a user input. Optionally, the user interface comprises a button or a touchscreen. Optionally the user interface is configured to instruct the controller to change the type of information shown by the display. For example, a token of the invention is configured to show a code produced by an algorithm and optionally further configured to show one or more of (e.g. each of) the date, time, token hardware identifier (e.g. serial number), and a second code produced by an algorithm. The controller can optionally be configured such that operation of the user interface (e.g. button pushing) causes the display to switch from showing the code to showing another type of information of which the token is capable of showing, e.g. cycling from one information type to the next each type the button is pushed.

### Token Power Source

A token of the invention comprises, or is configured to connect to, a power source for powering at least the controller and the display.

Optionally, the power source is a battery.

Alternatively, the power source is optionally a transformer of alternating current to direct current (e.g. for plugging into an AC outlet).

### Other Features

In addition to or as an alternative to a display, a token can comprise a wireless transmitter for sending token information such as codes produced by the token, token time, or token ID.

Examples of wireless transmitters include Bluetooth transmitters or near field communication (NFC) transmitters.

Optionally, the wireless transmitter or controller is configured to limit the distance through which the wireless transmitter can transmit data (e.g. codes). Such an embodiment ensures that a user actually visits the site (e.g. security checkpoint) at which the token is mounted rather than receiving codes from far away.

If the token comprises a wireless transmitter, the invention can provide a system of a mobile device comprising software for receiving the transmission, and optionally configured to send the transmission to a validation module (e.g. code or time) or synchronization module (e.g. time)

### System

In one aspect, the invention provides a system comprising at least one server computer and a token of the invention (or any other token that produces a code from an algorithm that uses a first correlation of date and time such as a hash algorithm). The server comprises a controller and a non-transitory a computer-readable medium storing a validation algorithm that uses the same time-code correlation (e.g. secret key) as the token's algorithm. The use of the same time-code correlation allows the validation algorithm to identify codes produced by the token and the time(s) at which the codes were produced, or vice versa.

Optionally, the system comprises a plurality of tokens, each having a unique token identifier (e.g. hardware identification such as serial number) and a unique algorithm (e.g. unique secret key), and the system comprises a server storing a plurality of algorithms, each corresponding to (i.e. having the same time-code correlation as) a respective token of the plurality of tokens and each associated with the token identifier of the respective token.

The server can comprise a validation module configured for correlating token times to token codes.

The server can also comprise a registration module configured to grant a server user access to the validation module.

Optionally, the module(s) of the system are provided on a server that is accessed locally (i.e. directly) by a user. Alternatively, the module(s) of the system are provided on a server that that is accessed remotely over a network by a user. In such an embodiment comprising a network, a remote terminal can be provided with an interface(s) for the module(s). Thus, certain steps of any module taught herein can be carried out by the server's module or by the remote terminal's module. For example, when a module is accessed via a remote terminal, the steps of interaction with the user (e.g. receiving in input from the user or outputting to the user such as displaying) can be carried out by the interface module.

Optionally, when a system comprises a validation module and a synchronization module, the validation module and the synchronization module are comprised by a server, and one or more networked remote terminals have a validation module interface (a module for allowing the user to interface with the validation module) and/or a synchronization module interface (a module for allowing the user to interface with the synchronization module)

Optionally, when a system comprises a validation module and a synchronization module, the validation module and the synchronization module are comprised by different computers that are networked. Optionally, the synchronization module is provided on a remote terminal that includes a validation module interface (for interfacing with the validation module).

Computers

A system of the invention comprises at least one computer configured as a server of a module. Optionally, the system comprises one or more additional computers configured as remote clients that can communicate with the server via a network.

Computers useful in systems of the present invention comprise:
a. a controller;
b. one or more storage devices comprising a non-transitory computer readable medium;
c. a structure configured for connecting the controller to the other components (e.g. storage device and network access device) of the computer; and
d. optionally a network access device (or ‘network device’), e.g. when the system comprises a network.

A non-transitory computer readable medium of a computer acts as a storage device and stores a module (e.g. validation module) and optionally an algorithm (e.g. validation algorithms) for performing computer functions taught herein.

Useful non-transitory computer-readable media includes any physical media configured to store code and be readable by a computer. For example, useful computer-readable media computer includes volatile media, nonvolatile media, removable media, non-removable media, RAM, ROM, EEPROM, flash memory or other memory technology, CD-ROM, digital versatile disks (DVD), holographic media or other optical disk storage, magnetic cassettes, magnetic tape, magnetic disk storage, or other magnetic storage devices.

Useful controllers include any processor (e.g. microprocessor or central processing unit) configured to access the computer readable media and optionally the network access device. Examples of such processors are well known in the art and are commonly connected to storage devices and network access devices by a system bus (e.g. on a motherboard).

Useful network access devices include any devices configured to transmit data between the computer and the network. Examples include network adapters wired adapters such as ethernet adapters and wireless adapters such as Wi-Fi adapters (e.g. 802.11 adapter) and cellular adapters (e.g. GSM, TDMA, CDMA, 3G, and 4G adapters).

Useful structures configured for connecting the one or more processors to other components include, e.g. a motherboard comprising a northbridge and southbridge. Other structures that can be present are well known in the art, e.g. as seen in desktop computers and commercial servers.

Optionally, a computer comprises a user input device. A user input device can be any device or combination of devices configured for operation by a user to operate the computer and/or a module that can be access by the computer. Optionally, the input device comprises a keyboard, mouse, touch screen, a keypad, one or more buttons, one or more scroll wheels, or one or more buttons or other device that can be operated by a user. Optionally, the input device comprises a microphone or a camera.

Optionally, a computer comprises a display. The display can be any output device that produces a graphic viewable by the user. Optionally, the display is selected from: an LCD, an LED, and a monitor.

Computers can be stationary computers (e.g. AC-powered computers), a mobile device (e.g. battery powered computers or laptops, e.g. that are sized for easy transport), a handheld computer. Optionally a mobile device is a handheld computer or a cellular phone such as a smartphone, or a cellular data-enabled PDA or tablet PC.

Server

A system of the invention can comprise a server. The server is optionally any computer configured to run a validation module and/or a synchronization module taught herein. The validation module can optionally be configured for use by a person to correlate token-produced codes to a corresponding time at which the code was produced. The synchronization module optionally can be configured for use by a person to inform the validation module (or validation algorithm) of the current time provided by the token and/or determine token clock drift and apply a corresponding time shift to the code-time correlation used by the validation algorithm. Accordingly, a server optionally comprises network adapter to allow a remote client to access the server's modules over a network, or a user input device and a display to allow a user to access the server's module directly from the server.

Optionally, the server comprises a module configured to provide an interface (e.g. a visual or graphic interface), e.g. for interfacing with other modules of the server (e.g. validation module or synchronization module).

Remote Terminal

A system of the invention optionally comprises a remote terminal. Optionally, a remote terminal is any computer configured to network with a server of the invention. The remote terminal optionally comprises a network adapter, a user input device, a display, and a module configured to provide an interface (e.g. a visual or graphic interface), e.g. for interfacing with other modules of the server (e.g. validation module or synchronization module).

Useful remote terminals include any computer taught herein.

In one embodiment, the system comprises a mobile device that can access a synchronization module (e.g. locally on the mobile device or via a network). In this embodiment, a mobile device is especially useful because it allows a user to travel to the location of a token (e.g. a wall-mounted token) and visually obtain the token's clock time for input into a synchronization module via the mobile device. In this embodiment, optionally the mobile device is either also a server running a validation module, or is networked with a server running a validation module. Thus, the validation module (or validation algorithm) can have its time-code correlation modified using an identified time shift corresponding to the token's clock drift.

Modules

According to a system of the present invention, a module is provided on a non-transitory computer-readable medium. Modules are compilations of instructions (‘code’) executable by one or more computers to perform a function. The modules can be provided on any computer readable media (e.g. storage devices) assessable by the one or more computers. Any type of module is useful in the present invention. Collectively, one or more modules are optionally configured for providing any method of the present invention. Although detailed module logic/procedures are provided for certain steps in the present methods, the skilled artisan, with the teachings provided herein, can readily configure the modules to provide any methods or steps taught herein in a number of manners. For brevity, a module is sometimes said to be comprised by a computer or a system, which means that the module is stored on a non-transitory computer-readable medium accessible (locally or networked) to the computer or the system.

Optionally, a system of the present invention comprises one or more of a validation module, a synchronization module, and a registration module. The modules can be stored on the same or different computer readable media and/or stored on the same or different computer (e.g. networked computers). The modules can be included together in a single application (e.g. located on a server, wherein the application can be operated by a local user input device and display or accessed by a networked remote terminal) or can be included in distinct applications configured to interact with each other to provide the methods taught herein.

The modules can be configured, for example, as a program, an application, an applet, a macro, a script, a subroutine unit of code, a software function unit of code, an object (as in an object-oriented paradigm), firmware, or any other type of computer code. The code can include any code, e.g. source code, object code, machine code, or any other stored data that is operable to cause a processing system to perform methods described herein.

The code and functionality of a given module can be located on a single computer or distributed across multiple computers.

Validation Module

Optionally, a computer of the system comprises a module configured for validating token codes by correlating token times to token codes (‘validation module’) using a validation algorithm.

The validation module can be configured to perform steps of:
a. receiving an input (e.g. user input via a user interface such as a keyboard) comprising a time or code;
b. use the validation algorithm to determine a code corresponding to the input time or determine a time corresponding to the input code; and
c. output the determined corresponding code or time to the user, e.g. via a user interface (e.g. display or printer) or network (e.g. email).

Optionally, the system comprises a plurality of tokens, and the validation module performs steps of:
a. receiving a user input that identifies a token from the plurality of tokens; and
b. selecting from a plurality of validation algorithms a validation algorithm that corresponds to the identified token (e.g. uses the same time-code correlation such as by secret key), wherein the step of selecting is performed to select the validation algorithm for the step of using the validation algorithm to determine the corresponding code or time.

Optionally, the step of receiving an input code or time comprises receiving a discrete time or a time range. As used herein, the term ‘discrete time’ refers to a time that corresponds to only a single code. For example, if the update interval of a token is 24 hours that starts and ends at midnight (and the input time is in the same time zone as used by the validation algorithm or token), the discrete time could be a time accurate to the minute (e.g. 10:25 PM, 13 Mar. 2017), hour (10 PM, 13 Mar. 2017), or day/date (13 Mar. 2017). As used herein, the term ‘time range’ refers to a time that corresponds to a plurality of codes. For example, if the update interval of a token is 24 hours that starts and ends at midnight, the time range could be a time that corresponds to more than one calendar day such as a time accurate to the month (e.g. March 2017) or week (e.g. week 3, March 2017).

Optionally, the step of receiving an input code or time comprises receiving a plurality of discrete times and the step of outputting the determined corresponding code comprises outputting, following the step of receiving the plurality of discrete times, a plurality of determined corresponding codes, wherein each of the outputted corresponding codes corresponds to a respective input discrete time. Optionally, the outputted plurality of codes is provided in list form (e.g. with each code provided on a separate line).

Optionally, the step of receiving an input code or time comprises receiving a historical local time or a historical world time (e.g. Greenwich Mean Time (‘GMT’) or Coordinated Universal Time (‘UTC’)), e.g. as a discrete time. In this embodiment, the step of using the validation algorithm to determine the code corresponding to the input time optionally comprises correlating the input time to a clock time used by the validation algorithm (e.g. when the validation algorithm uses a clock time that is time-shifted from the time zone relied on for the user input). Further, in this embodiment, the step of outputting the determined corresponding code optionally comprises outputting a single code corresponding to the input time, e.g. when the input time corresponds to only a single code.

Optionally, the step of receiving an input code or time comprises receiving a time range (e.g. week or month) and the step of determining a code corresponding to the input time comprises determining a plurality of codes corresponding to the time range and the step of outputting the determined corresponding code comprises outputting the plurality of determined codes. Optionally, the outputted plurality of codes is provided in list form (e.g. with each code (or code pairs if the input time zone is different than the validation algorithm time zone) provided on a separate line).

Optionally, the step of receiving an input code or time comprises receiving a plurality of time ranges and the step of outputting the determined corresponding code comprises outputting, following the step of receiving the plurality of time ranges, a plurality of determined corresponding codes, wherein each of the outputted corresponding codes corresponds to a respective time occurring within the plurality of time ranges. Optionally, the outputted plurality of codes is provided in list form (e.g. with each code (or code pairs if the input time zone is different than the validation algorithm time zone) provided on a separate line).

Optionally, the step of receiving an input code or time comprises receiving a plurality codes and the step of outputting the determined corresponding time comprises outputting, following the step of receiving the plurality of codes, a plurality of determined corresponding times corresponding to a respective input code (or code pair if user time zone is different than validation algorithm time zone). For example, when the update interval of a token is 24 hours, the outputted plurality of times can be a plurality (e.g. list) of dates (e.g. 13 Mar. 2017; 14 Mar. 2017; etc.). Optionally, the outputted plurality of times is provided in list form (e.g. with each time provided on a separate line).

Optionally, the step of receiving a user input that identifies a token from the plurality of tokens comprises receiving a keyed (e.g. typed) token-identifying input, a user selection of a token-identifying item from a drop-down menu, or radio button. Optionally, the token-identifying input or token-identifying item comprises a token identifier (e.g. hardware identification or serial) or a keyword associated with the token (e.g. token name or token location name such as room name).

In order for the validation algorithm to correctly correlate token-produced codes with the time at which the codes were (or would have been) produced, the validation algorithm can optionally receive the user's time zone and/or token drift for input into the validation algorithm. While the token clock time can optionally be synchronized with a clock server at manufacture initially, a system of the invention additionally or alternatively optionally comprises a synchronization module configured to inform the validation algorithm of the token's clock drift (e.g. providing an appropriate time shift).

Optionally, the validation module (or other module on the server or on a networked server) is configured to create a fillable form (e.g. printable form) having defined blanks (e.g. lines) that can be filled by a user (e.g. hand written or typed into), and the step of outputting a code or time comprises outputting a plurality of codes or times in the same format (e.g. line spacing) as the fillable form. Such a module allows a first user to print the fillable form, record the token's codes on the fillable form, and a second user to receive an outputted list of codes (and times) from the validation module for easy comparison to the list of codes recorded by the first user (e.g. such that the two lists of codes can be placed side by side for verification of identicalness, e.g. having codes on different lines with the same line spacing between the two lists). Optionally, the validation module is configured to provide the fillable form with a range of date labels and spaces next to the dates and optionally provide the same date range as a selectable date input into the validation module for retrieving corresponding codes (e.g. the validation module provides a selectable date for input into the validation algorithm as the date range of the fillable form produced).

As depicted in FIG. 16, the validation module can be configured to create (e.g. print) the form labeled “Employee-filled code sheet” with blanks for a user to enter codes on the scheduled date (as shown, the codes in the “Employee-filled code sheet” are hand-written) and optionally pre-populate the dates for a given date range (e.g. March 5, March 6, etc.). As further shown in FIG. 16, the validation module can be configured to output codes (e.g. based on a time input) in a format that is the same or similar as the fillable form. FIG. 16 shows the “Validation code sheet” having the same or similar line spacing such that the “Employee-filled code sheet” can be laid next to it for easy comparison of the codes. Optionally, the code spaces in the fillable form are justified to one side (e.g. right justified as shown) of the fillable form, and the validation code sheet has codes justified to another side (e.g. right side) to provide the codes in close proximity to each other when the lists are laid next to each other. The “Validation code sheet” is optionally produced (e.g. printed) by a user by selecting the date range (e.g. “March 2017 week 2”) from a drop down menu, e.g. after the fillable form having the same date range was already produced by the module (e.g. when the March 2017 week 2 fillable form was already produced using the module).

Optionally, the validation module is configured for receiving a code and determining a time corresponding to the input code.

A validation module that receives a code input and outputs a time can use a validation algorithm that relies on the time-code correlation of the token algorithm, but provided in an inverse manner to the token algorithm (i.e. an inverse algorithm that receives code as an input and outputs the corresponding time).

Certain token algorithm strategies have become increasingly difficult or impossible to inverse (e.g. algorithms with hash functions such as HMAC or HOTP). Accordingly, as another example, a validation module that receives a code input and outputs a time can use a validation algorithm that relies on an algorithm that calculates code based on time (e.g. in a similar manner as does the token algorithm) and calculates a plurality of codes from a plurality of times (in addition to the code input by the user), and then outputs to the user, from the plurality of times passed through the algorithm, a subset (or single time) of the plurality of times that corresponds to the time input by the user.

For example, the validation module can be configured to perform steps of:

1. Receive a code input from user, and optionally receive a time range from the user (e.g. a selected week or month);

2. Pass a plurality of times (e.g. a time from each update interval within the time range received from the user) through the algorithm to obtain a plurality of code outputs corresponding respectively to the plurality of times (e.g. in a table of “code vs. time”);

3. Parse (or search) the obtained plurality of output codes to find the code input from the user and identify the corresponding time(s), and

4. Output the corresponding time(s) to the user (e.g. via display, email, printing, or saving on a storage device).

To perform such a process, the validation module (or interface thereof) optionally prompts the user to input a time range (e.g. week or month) to combine with the user's code input. Then, the validation module only passes the times corresponding to the time range through the validation algorithm, sparing the controller excessive work (i.e. reducing the size of the table which the controller creates and parses), and can find the output codes that match the user's input code.

Registration Module

Optionally, a computer of the system comprises a module configured to grant a user access to the validation module (‘registration module’).

Optionally, the registration module is configured to:
a. receive an input identifying a user (e.g. user ID, email address, or remote terminal interface module ID);
b. receive a user input identifying a token (e.g. serial number or sales ID associated with the token); and
c. associate the user with a validation algorithm (which is used by the validation module) corresponding to the token identified.

Optionally, (e.g. when the server is used by multiple users that have access to different tokens), the registration module is configured to:
a. create a user account unique to the user (or set of related users such as members of a company); and
b. associate the user account with the user.

Associating a user account with a user can include, for example, creating a user login and/or password that, when later received from a user, grants access of the user to the associated validation algorithm(s), e.g. through a website.

Optionally, the registration module is configured to:
a. receive a user input comprising a time zone; and
b. either:
   i. associate the input time zone with the validation module such that time inputs received by the validation are automatically labeled with the time zone input to the registration module; or
   ii. modify the validation algorithm to function based on the time zone received by the registration module, e.g., such the validation module does not need to prompt the user for his time zone each time he uses the validation module.

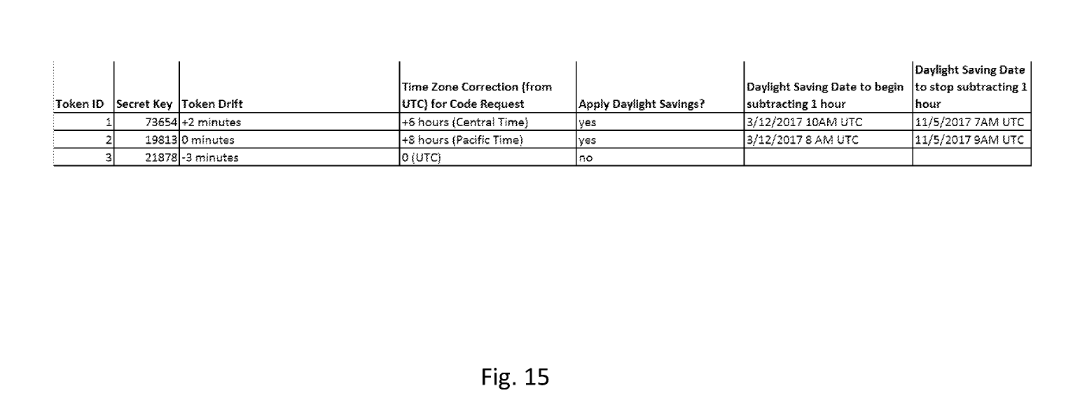

For example, the registration module can fill time zone variables used by the validation algorithm, as shown in FIG. 15.

Optionally, the registration module is configured to, following the step of receiving a user input identifying a token, output to the user (e.g. via display, printing, or network communication) a list of token(s) associated with the user.

Optionally, the registration module is configured to prompt a user to input keywords associated with the token ID (e.g. Building or Room name or ID) and the validation module associates the keyword with the token ID, and then provides these keywords for selection by the user when using the validation module (e.g. where the validation module can later select the appropriate token ID based on the keyword input by the user).

Synchronization Module

Optionally, a computer of the system comprises a module configured to synchronize the time-code correlation used by the validation algorithm with the clock used by the token. Such a module is referred to herein as a synchronization module.

In order to more accurately correlate codes that were (or would have been) produced by the token with the respective times at which they were produced, the time-code correlation of the validation algorithm can be synchronized with the token's clock. While nearly all clocks experience some degree of drift (i.e. error) over time, this drift has not presented a problem in prior art OTP tokens because the drift is immediately recognized by the validating server when user logs in with their token password (e.g. based on the identification of a password that is one iteration forward or backward), and the validating server can simply shift its own time to match that of the drifted token clock. However, in some embodiments, the present invention is specifically designed to provide the user with a code that is recorded and validated later (i.e. a based on a historical time, e.g. for later site visit verification). Thus, real time synchronization of server and token clocks may not possible. Thus, it can increase accuracy of a validation module if its validation algorithm takes any token clock drift into consideration.

A synchronization module useful in a system of the invention is optionally a module which can be operated by a user.

The synchronization module is optionally configured to:
a. receive a token's clock time (e.g. via user input);
b. determine a difference between the token's clock time and a comparator clock, thereby identifying a time shift; and
c. apply the determined time shift to the validation algorithm (e.g. such that the validation algorithm uses the time shift for future code/time correlations).

The step of applying the identified time shift to the validation algorithm can optionally comprise changing a step (e.g. time-correlation step) of the validation algorithm or modifying a variable referenced by the validation algorithm such as a variable in a reference table (e.g. as shown in FIG. 15).

The step of receiving a token's clock time optionally comprises receiving (e.g. following prompting the user for) an input of the token's clock time using a user input device (e.g. touchscreen or other keypad of a remote terminal such as a mobile device). Alternatively, the step of receiving a token's clock time optionally comprises receiving the token's clock time via data transmission from the token (e.g. via wireless transmission such as Bluetooth or wired transmission such as USB) or by taking a picture of the token (e.g. recognized via OCR).

The synchronization module is optionally provided on a server (e.g. the same server comprising the validation module and validation algorithm) wherein the system comprises a remote terminal (e.g. mobile device) comprising an interface module configured to interface the synchronization module with the user (e.g. providing a visual interface which can accept user inputs) or the token user (e.g. providing an interface which can accept a clock time transmission from the token).

Optionally, the comparing step comprises comparing the token time to a clock server, e.g. via Network Time Protocol (‘NTP’) or server there for.

Optionally, the tokens clock time is calculated from a user input by adding a specified amount of time to a user's input. This allows a user to, for example, enter the clock time shown by the token, and wait until the token clock time is updated (e.g. changed to the next minute) before sending another user input that starts the step of comparing. As an illustrative example, a mobile device (e.g. cellular device or smartphone) can be provided with an server interface module that provides a user interface where the user enters the existing clock time shown by the token, which is then compared to the clock server time (e.g. via the mobile device's module or the server's module), and an identified time shift is used to synchronize the server's time (e.g. via NTP). For example, a user enters the token's shown time into the module, waits for the clock to change to the next minute and at that instance taps a “SYNC” button on the module/application.

Optionally, the synchronization module is configured to receive the token's displayed clock time from the remote terminal (e.g. operated by the user) and determine the latency (i.e. transmission time, e.g. via ping) between the server on which the synchronization module is housed and the remote terminal and then modify the token clock time by adding the transmission time to the token clock time received on the remote terminal.

Optionally, the comparator clock is housed on a clock server remote to the server on which the synchronization module is housed, and the synchronization module is configured to determine the latency (i.e. transmission time, e.g. via ping) between the synchronization module's server and the comparator clock's server and then modify the token clock time by adding the transmission time to the token clock time.

Optionally, the system (e.g. synchronization module) compares an identified time shift to a threshold time shift and transmits an alert. For example, the alert can be sent via email or to an alert-receiving module (e.g. an admin's system interface module) or to any predetermined network device, printer, or display) when the identified time shift exceeds the threshold time shift (e.g. to inform an admin that the token's clock as drifted excessively and the token should be replaced or sent in for calibration.

Optionally, the steps of receiving a token's clock time and comparing the clock time to a comparator clock are repeated a plurality of times (e.g. over a period of time), and the synchronization module is configured to calculate rate of drift (e.g. rate of change of drift over a period of time), AKA, a drift speed based on the plurality of comparisons. Additionally or alternatively, the synchronization module is configured to calculate the rate of change of the drift rate (e.g. rate of change of drift speed over a period of time), AKA, a drift acceleration. In such embodiments, an alert (as described in the preceding paragraph) can also be sent when the synchronization module determines the drift speed or drift acceleration exceeds a threshold drift speed or drift acceleration.

Optionally, upon calculation of the drift speed or drift acceleration, the synchronization module is configured to send the drift speed or drift acceleration to the verification module and the system (e.g. the verification module or synchronization module) is configured to update the token drift variable (e.g. in FIG. 15) periodically in accordance with drift speed or drift acceleration (e.g. even in the absence of a future drift calculation from an input token time) or provide a variable of drift speed or drift acceleration that is referenced by a validation module or algorithm to determine the time-code correlation. Thus, the system can optionally use the drift speed or drift acceleration to predict the future tokens drift, even in the absence of a direct drift calculation from the input of a tokens current time.

As an alternative to the step of synchronizing the validation algorithm, the synchronization module can be configured to synchronize the token's clock, e.g. by sending the identified time shift to the token via data transmission from the server or remote terminal (e.g. via wireless transmission such as Bluetooth or wired transmission such as USB).

As an alternative to providing the synchronization module on a server, the token can optionally comprise a module configured for receive a comparator clock's (e.g. clock server's) time (e.g. via wireless transmission such as Bluetooth or wired transmission such as USB, from the server or a remote terminal networked with the server); determine a difference between the token's clock time and the comparator clock thereby identifying a time shift; and synchronize the token's clock based on the identified time shift.

Administration Module

A system of the invention optionally comprises a module stored on memory (e.g. of the server or a remote terminal), configured to perform administrative functions (‘administration module’).

Optionally, the administration module is configured to perform any of the following functions:
a. add new token identifiers and associate token identifiers with respective validation algorithms (or time/code correlation definitions thereof); and
b. receive alerts from other modules of the system (i.e. act as an alert-receiving module), for example, an alert that a token's clock has drifted as identified by a synchronization module.

The administration module can optionally provide a user interface for receiving inputs from a user (e.g. via user input device) and displaying information to a user (e.g. via a display). If the administration module is provided on a single server, the administration module can be configured to interface with modules of a remote terminal (e.g. remote terminals operated by administers) to allow the user of a remote terminal to operate the administration module.

Interface Modules

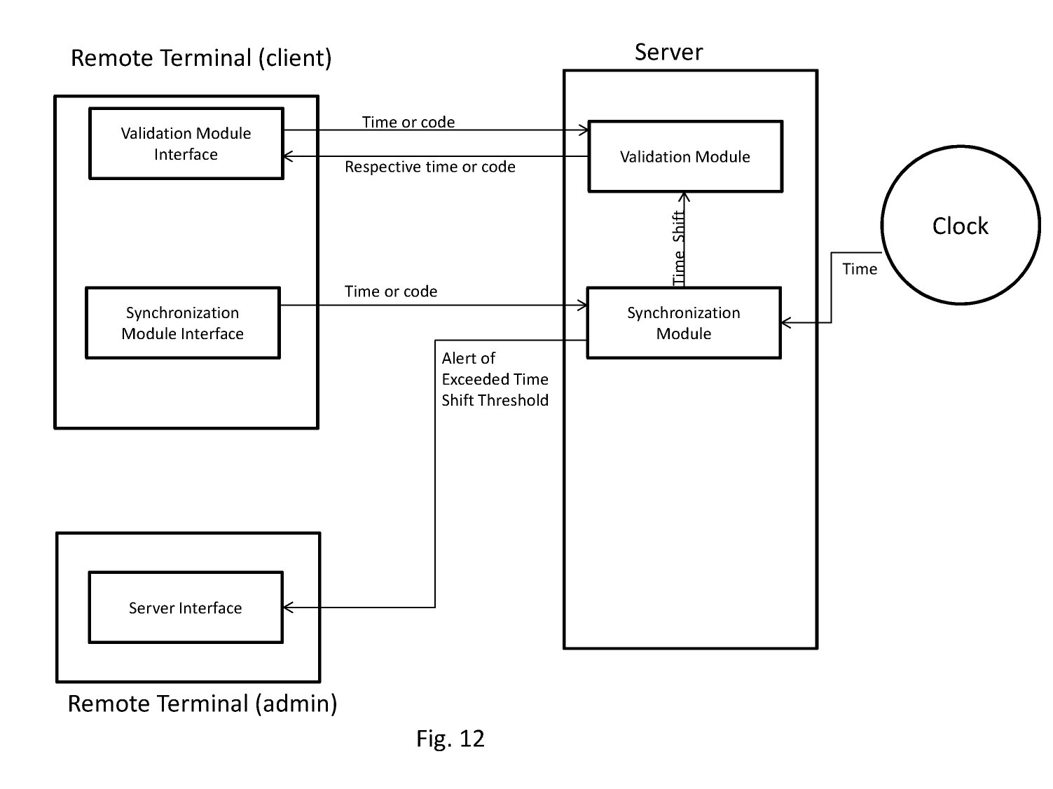

A system of the invention optionally comprises one or more interface modules. An interface module (sometimes referred to simply as “interface”, e.g. in FIG. 12) is a module configured for interfacing a user or remote terminal with another module. The interface module can be used send or receive data from the other module. Further the interface module can optionally display data received from the other module or prompt a user (e.g. via a display) to input data that is sent to the other module.

Optionally, a system of the invention comprises (e.g. on remote terminals networked with a server comprising the interfaced module) an interface module for interfacing with a validation module, an interface module for interfacing with a synchronization module, and/or an interface module for interfacing with a registration module.

Examples of interface modules include websites, phone applications configured specifically to interface with the other mule (e.g. downloadable programs from an app store on an iPhone or Android phone), or installable programs on a computer (e.g. Windows or Macintosh based PC).

Optionally the other module(s) of the system is provided on a server that that is accessed remotely over a network by a user. In such an embodiment comprising a network, a remote terminal can be provided with an interface(s) for the module(s).

Optionally, when a system comprises a validation module and a synchronization module, the validation module and the synchronization module are comprised by a server, and one or more networked remote terminals have a validation module interface (an interface module for allowing the user to interface with the validation module) and/or a synchronization module interface (an interface module for allowing the user to interface with the synchronization module).

Optionally, when a synchronization module is provided on a server (e.g. the same server comprising the a validation module and validation algorithm), the system comprises a remote terminal (e.g. mobile device) comprising an interface module configured to interface the synchronization module with the user (e.g. providing a visual interface which can accept user inputs) or the token user (e.g. providing an interface which can accept a clock time transmission from the token).

Network

A system of the invention optionally comprises a communications network (‘network’) to connect a plurality of computers together.

The plurality of computers can optionally include a server running a validation module and one or more of a remote terminal (or multiple remote terminals) running an interface module for interfacing with the validation module. Optionally, the network comprises a mobile device (or multiple mobile devices) running a synchronization module (or interface thereof). The network can be any network that can transmit the data disclosed herein between the computers.

Useful networks include wireless networks, wired networks, and a combination thereof.

Optionally, the network comprises a wide area network (WAN) or a local area network (LAN).

Optionally, the network comprises a wide area network (WAN). Optionally, the WAN comprises the internet. Optionally, the WAN comprises a wireless WAN such a cellular network. Optionally, the WAN comprises the internet and a wireless WAN (e.g. cellular network).

Optionally, the network comprises a wireless network. Optionally, the wireless network comprises a cellular network, a wireless local area network, or a wireless metropolitan area network.

Optionally, the network comprises a cellular network. Useful cellular networks include Advanced Cellular telephone System (AMPS), Narrowband Advanced Cellular telephone Service (NAMPS), Frequency Shift Keying (FSK), Frequency Division Multiple Access (FDMA), Time Division Multiple Access (TDMA), and Code Division Multiple Access (CDMA), or any standard, such as Global System for Mobile communications (GSM) or Cellular Digital Packet Data (CDPD), a GPRS network, an EDGE network, a 3G network, and a 4G network.

The network can use any network protocol, for example, an internet protocol, TCP/IP or UDP, which are commonly used over the internet.

### System Methods

One aspect of the invention provides method that can be carried out on a computer. A computer-based method comprises steps of causing a computer to perform functions any module taught herein. For example, the invention contemplates a method of causing a computer to function as a validation module or a synchronization module.

One validation method of the invention comprises causing a computer controller to:
a. receive an input comprising a time value or a code value; and
b. use an algorithm that correlates time value and code value to calculate a code corresponding to the input time value or a time corresponding to the input code value (e.g. a validation algorithm hat uses the same time-code correlation as a token); and
c. output the corresponding code or time.

If the input is a time value, the time value is optionally not received from a transmission (e.g. frequency signal) from a clock (in contrast to prior art validation servers that receive clock time from a clock server for instantaneous OTP validation). Instead, the time value is received from a user input (e.g. keyed entry or selection from a drop down box) or from a storage device (e.g. USB drive or memory of a mobile device).

Optionally, the update interval of the algorithm is at least 4 hours, e.g. at least 12 hours or at least 24 hours.

Optionally, the code is a short code, e.g. 3-5 (e.g. 4) characters.

Optionally, the controller applies a time shift to the time value before using the time value in the algorithm. Optionally, the time shift is determined based on a time zone received by user input to correct for time zone shifts between the token clock and the user's time zone.

Optionally, the time value input comprises a date. Optionally, the time value is precise to the day and not to the minute or not to the hour.

Optionally, the step of receiving a time value input comprises a receiving a plurality of time values or a time range prior to using the algorithm, and the step of outputting comprises outputting a plurality of codes corresponding respectively to the plurality of time values or corresponding to the time. Optionally, the plurality of time values or time range comprises a plurality date values (e.g. not precise to the hour or minute) or a range of dates (e.g. a week or a month).

Optionally, the step of receiving an input comprises receiving the input from a networked computer.

Optionally, the step of outputting comprises transmitting the output to a networked computer.

Optionally, the step of outputting comprises displaying the output, printing the output on a printer or sending the output to an email address.

Optionally, the method comprises, prior to receiving an input, prompting a user, via a local or networked display, to input the time. Optionally, the prompt comprises a prompt for text entry or menu selection (e.g. calendar selection) of time.

Optionally, the method comprises using two algorithms that have different correlations of time and code value and determining times and respective codes using both algorithms, and the step of outputting comprises outputting the codes or the times produced by both algorithms. Optionally, the update interval of each of the algorithms is the same. Such a method can optionally be used for a token that uses two algorithms to produce different (e.g. first and second) codes.

Optionally, the method comprises, prior to receiving an input, prompting a user, via a local or networked display, to identify a token identifier from a plurality of token identifieres (e.g. via selection from a menu) and, prior to the step of using the algorithm, the method comprises selecting the algorithm for use from a plurality of algorithms based on the identified token.

Optionally, the method comprises creating a fillable form (e.g. printable form or savable form such as PDF) that can be filled by a user (e.g. hand written or typed into), and the step of outputting a code comprises outputting a plurality of codes in the same format (e.g. line spacing) as the fillable form, e.g. as depicted in FIG. 16. Such a method allows a token user to read the display of a token and fill the fillable form with codes, and provides the output from the validation process in a format that is easily comparable to the filled form (e.g. such that the two lists of codes can be placed side by side for verification of identicalness).

Optionally, the method comprises carrying out a step to perform any other function of a validation module taught herein.

The invention also contemplates a non-transitory computer readable memory comprising instructions that, when read by a controller, cause a computer to carry out a validation method taught herein.

One synchronization method of the invention comprises causing a computer controller to:
a. receive a first clock time;
b. determine a difference between the received first clock time and a comparator clock, thereby identifying a time shift; and
c. apply the identified time shift to the time input or time output of a validation algorithm that correlates time and code value (e.g. any validation algorithm taught herein), e.g. by updating a token drift variable of a table of algorithm variable(s).

Optionally, the method comprises causing the controller to
a. receive a user input comprising a second clock time; and
b. add a period of time to the second clock time, thereby producing the first clock time (e.g. where the user waits until a token time changes to the next minute before executing a synchronization process).

Optionally, the first clock time or the second clock time is received from a networked computer and the method comprises causing the controller to determine a time latency of transmission between the controller and the networked computer and then to modify the first clock time by adding the time latency before determining a difference between the received first clock time and the comparator clock.

The invention also contemplates a non-transitory computer readable memory comprising instructions that, when read by a controller, cause a computer to carry out a synchronization method taught herein.

Optionally, the method comprises carrying out a step to perform any other function of a synchronization module taught herein.

One token code-recording method of the invention comprises causing a computer (e.g. mobile device) controller to:
a. recorded an image of a token using a camera;
b. perform optical character recognition (OCR) on the image, thereby determining the code shown by a token;
c. record the code on a non-transitory computer readable medium or send the code to a networked server; and

then cause the computer controller or the controller of the networked server to either:
a. using the recoded code as an input to for a validation module (or validation method) e.g. taught herein;
b. comparing the code to a code to a code output by a validation module (or validation method) and outputting (e.g. displaying, printing or emailing) a report of determinations of identical codes or different codes based on the comparison; or
c. providing a list of codes in a format (e.g. with same spacing) as a list of codes output by the validation module or validation method (e.g. such that side by side comparison of the two lists is easily performed by a user), e.g. as depicted in FIG. 16.

### Method of Token Use

A token of the invention can optionally be placed (e.g. mounted) at a given location. For example, the token can be placed in proximity to a target site such as a location, computer rack, room, door, gate, alarm panel, or anywhere a supervisor (or other person) requires a token user (e.g. employee) to visit or inspect at a specific time (or within a time window).

Each time a user visits or inspects the target site, the user may view the code displayed by the token and record the code. The step of recording the code can include any of handwriting the code (e.g. on a paper or fillable form), manually keying in the code (e.g. to a mobile device), taking an image of the token with a mobile device (wherein OCR is performed to determine the code), or receiving a wireless transmission from the token (e.g. via Bluetooth or NFC).

The large size of the characters and/or the short code makes it easy for a user to view and record the code without error, even from a distance or in a room with low lighting. Some people also have unusually poor mental capacity for remembering (even briefly) long codes. Thus, a short code (e.g. four characters) can help these people remember the code for the length of time between seeing and recording the code.

At the end of a desired time frame (e.g. a month), the supervisor can determine the times the token user (e.g. employee) recorded the code using a computer running a validation algorithm that uses the same time-code correlation as the token. For example, the supervisor can use a server of the invention to correlate the recorded codes with the times at which the codes were produced by the token. Thus, the supervisor can compare the times at which the token user (e.g. employee) was supposed to visit the site with the actual times the token user viewed the token to generate the codes.

Code checking of a token can optionally be used to determine if personnel was visiting a site, as directed, in the event of an incidence.

For example, if an alarm should have occurred but did not (or the alarm was not noticed), the employer can perform site visit verification to make sure that the employee had checked an alarm panel at which the token was mounted. Thus, the employer can be sure that the incidence did not occur due to human error.

As another example, if an incident occurred that should have been caught on camera, but was not, the employer can perform site visit verification to make sure that the employee had checked a video monitor near which the token was mounted.

Thus, the employer can be sure that the employee visited the video monitor at a time when the employee should have noticed the monitor was not working.

### EXAMPLES

The following is a detailed description of examples of embodiments of the invention. These examples, and any other examples taught herein, are not intended to provide one manner of carrying out the invention and not intended to limit the invention solely to the recited example.

### Example 1 Token

FIG. 1A depicts a token of the invention. The token comprises a housing 1 that surrounds, protects, and supports other components of the token. The token comprises display 2, which can be an LCD comprising a plurality of display elements 3 that can be independently controlled (e.g. turning on by applying a voltage to the element) to show information. FIGS. 1A and 1B depict the token with display 2 having all of the display elements off while FIGS. 2A-2D depict the same token with display 2 having selected display elements turned on (under control of a controller) to show various information.

The token optionally comprises a user interface 5 such as a button as shown in FIG. 1A. The user interface may be operated by a user (e.g. by pushing the button) to change the display state, for example, to change between the display states shown in FIGS. 2A-2D, e.g. changing the display state each time the button is pushed.

The token comprises one or more mounts 6, such as one or more eyelets as shown, which can be used to mount the token to a wall or other supportive structure. The eyelets can accept a screw or rivet for mounting the token. The wall mount demobilizes the token, ensuring that it is not removed from a specified site (e.g. a site an employer requires an employee to visit and record the token code for verification purposes).

The token housing 1 optionally comprises a front portion 7 and a housing back plate 8 which are secured together during manufacturing after internal components such as the display and controller and optional battery are installed inside the housing.

The housing 1 optionally comprises a display cover 9. For example, display cover 9 can comprise a transparent portion 11 (e.g. an anti-glare plastic window). Optionally, the display cover 9 comprises an opaque portion 10 surrounding the transparent portion 11, which may be provided as a black or contrasting color.

The display 2 and display elements 3 shown in FIG. 1A can be configured as a display having a plurality of display elements as depicted in FIG. 1B. Specifically the display can comprise a plurality of display element groups 27-33, each group providing a space for a single character (e.g. provided by multi-segment groups). Display element groups 27-33 each have the same shape, orientation and number of display elements (e.g. each as the depicted seven-segment group which forms an “8” when all seven segments are turned on). The display 2 can further comprise a plurality of non-standard display elements 34-37, each in the form of a predetermined annunciator or label (e.g. “password”, “date”, “time”, and “s/n” as shown). A respective annunciator can be turned on when the display groups 27-33 are controlled to show a given type of information (e.g. as shown in FIGS. 2A-2D).

The segments of any of display element groups 27-33 can be independently controlled to show a given character (e.g. number), and a plurality of display element groups selected from groups 27-33 can be selected to show a plurality of characters simultaneously, for example to show a code (e.g. using display element groups 27-30 as shown in FIG. 2A), a date (e.g. using display element groups 27, 28, 30, 31, 32, and 33, as shown in FIG. 2B), a time (e.g. using display element groups 30-33 (and 38), as shown in FIG. 2C), and/or a token serial number (s/n) or other token identifier a serial number (e.g. using display element groups 27-33 as shown in FIG. 2D).

As shown in FIG. 1B, the characters used to show the code are large in size, for example, having a height “H” of at least 0.7 cm and/or a width of at least 0.4 cm. The large character size increases a user's ability to quickly read a code without user error. For example, the character size can be about 1.1 cm in height and 0.6 cm in width to provide good readability from a distance or in dimly lighted environments.

As shown in FIG. 2A, the code is optionally a short code, for example, comprising four characters (characters provided by element groups 27-30). The reduced number of code characters increases a user's ability to quickly read (and write) a code without user error.

As shown in FIGS. 2A and 2C, the token can optionally be configure to asynchronously display two different informations which use the same number of identical display element groups (e.g. code 12 and time 16 both use four of the display element groups). To avoid confusing the reader as to which information is being shown (e.g. because both have four characters), the code 12 and time 16 are shown on different portions of the display 2. For example, the code 12 and be left-justified and the time 16 can be right justified, as shown in FIGS. 2A and 2C, or vice versa.

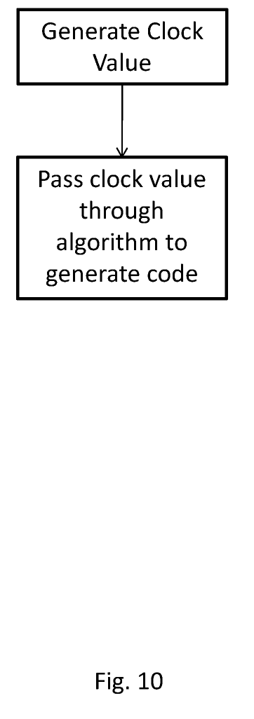

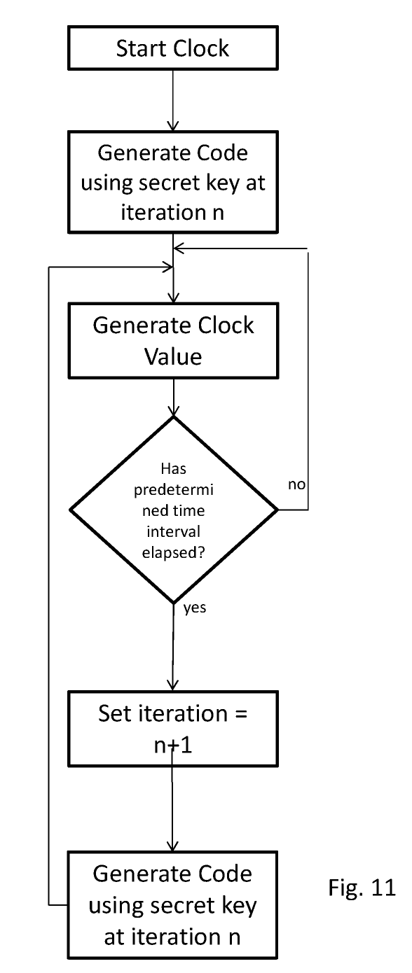

The code is a pseudorandom code produced using an algorithm stored on memory (e.g. non transitory computer readable medium such as RAM). The algorithm produces the code as a function of current time (e.g. as obtained by a clock either onboard the token or obtained from outside the token) and a secret key stored on the memory. The clock can be a UTC zone clock to provide a ubiquitous time or to facilitate synchronization. The algorithm can be any algorithm that produces a code of characters using a specific correlation of time and code character value. The algorithm is configured such that the code produced by the algorithm is different upon the elapse of a predetermined interval of time, i.e. an update interval. The code is updated every time the update interval elapses. For example, the controller can be configured to produce a code using a hash message authentication code (‘HMAC’) algorithm, or the serious of steps shown in FIG. 10 or FIG. 11. If passing a clock value directly through an algorithm, the clock time can optionally be rounded down or up to the next interval cutoff (e.g. midnight) defined by an update interval (e.g. 24 hour period).

The update interval of the code is optionally a long update interval (e.g. at least 12 or 24 hours). An update interval of 24 hours means that the same code is produced through a period of 24 hours, and a new code is produced throughout the next period of 24 hours, and so on.

A long update interval allows the use of a shorter code as less characters are needed to provide unique codes for all intervals in a given time period (e.g. 1 year). This is especially useful when an exact time is not required for verification (e.g. when an employee needs to visit a site once per day at any time, as detailed in Example 3).

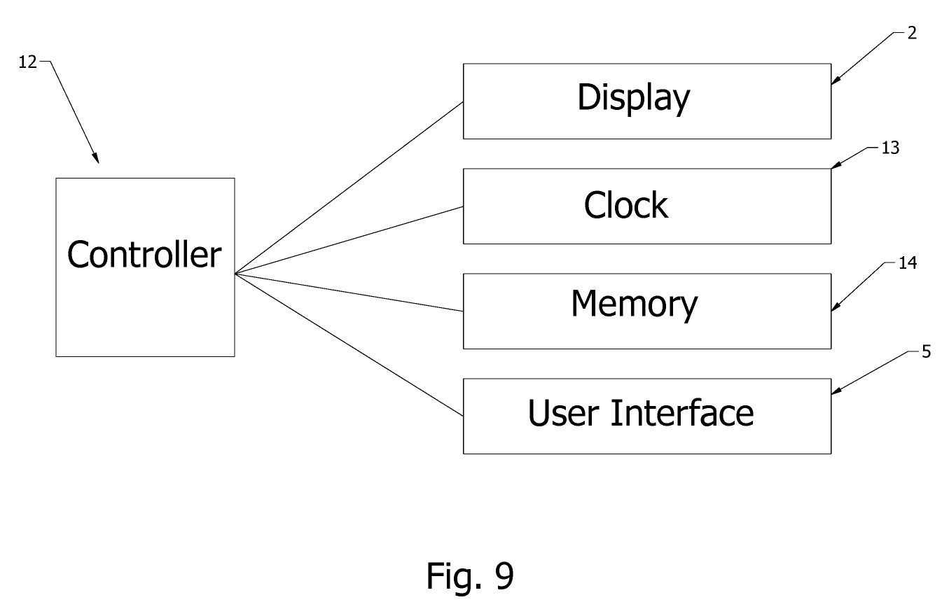

As shown in FIG. 9, the token can comprise a controller 12 which controls components of the token, for example, outputting to the display 2, an receiving a time signal from an onboard clock 13, reading the token algorithm from memory 14, receiving inputs from the user interface 5.

By example, the clock can be a quartz crystal such as a 32.768 kHz Tuning Fork Quartz Crystal.

### Example 2 Token Displaying Two Codes

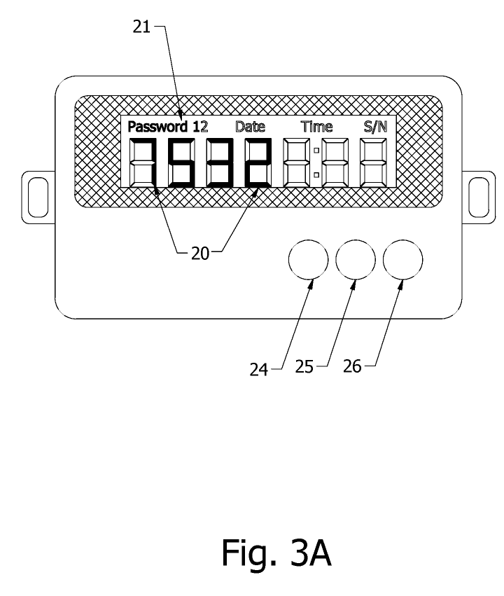

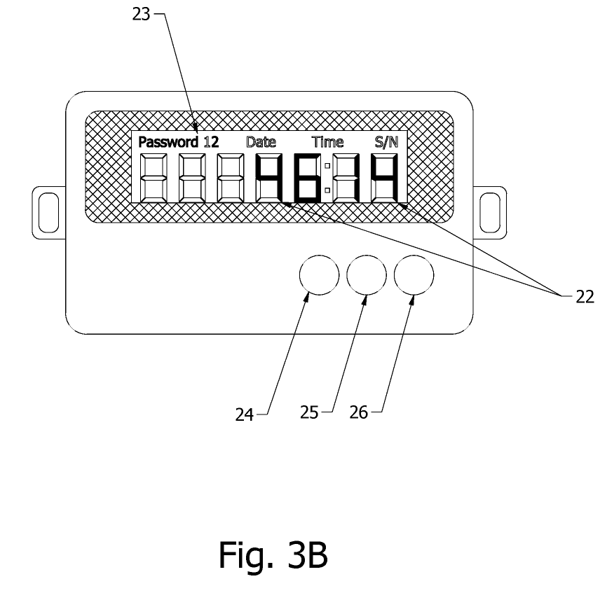

FIGS. 3A and 3B show a token similar to the token taught in Example 1, but configured to asynchronously show two different codes (e.g. having the same or different update interval), e.g. a first code 20 (“7532”) labeled by annunciator 21 (“password 1”) shown in FIG. 3A, and a second code 22 (“4614”) labeled by annunciator 23 (“password 2”) shown in FIG. 3B.

To avoid confusing the reader as to which code is being shown, a first code 20 and second code 22 are shown on different portions of the display 2. For example, the first code and be left-justified and the second code can be right justified, as shown in FIGS. 3A and 3B.

Optionally, the device comprises a plurality of operable interfaces such as buttons 24-26 for causing the display to shown different information. For example, a first button 24 or other user interface can cause the display to show the first code 20 and a second button 25 or other user interface can cause the display to show the second code 22. Optionally, a third button 26 or other user interface is provided for causing the display to show one or more other information types such as date, time, or serial number (e.g. switching between other information types each time the button 26 is operated).

Optionally, the controller is configured to wait a predetermined period of time between showing the first code 20 and showing the second code 22. This prevents a user from obtaining (and recording) both codes upon a single visit (or making it less convenient to do so by requiring a waiting time). Thus, if an employer wishes to use a multi-password (e.g. two-password) token to record an open (or start) code and a close (or finish) code, the predetermined waiting period helps ensure that the employee actually makes a second (close or finish) visit to inspect the site where the token is mounted rather than recording both codes on a single visit to the token (or stays at the token the required period of time to obtain start and finish codes rather than leaving early).

### Example 3 Use of a Token

A token of the invention (e.g. as detailed in Example 1 or Example 2) can optionally be used in any environment in which a user is required to visit a site. Specifically, the token is mounted at (or near) the site to which a user (e.g. an employee) is required to make periodic visits. For example, the site may be an alarm panel or a video monitor or a security checkpoint. The employee may be required to inspect the alarm panel to check that the panel is not in an alarm state or check that a video monitor is correctly working and/or recording.

Upon visiting the site, the user records the code (e.g. by hand in writing or by keying the code into a computer such as a mobile phone) from the token for later verification by the user's employer.

If the user is required to visit the site multiple time per day or stay at the token for a period of time, a multi-code token can be used, e.g. a token detailed in Example 2. The first code can be used to designate a first visit to the site or start time and the second code can be used to designate a second visit to the site or end time.

### Example 4 System of a Token and a Server Running a Verification Module

A system is provided comprising a token and a server which runs a verification module. The server is a computer having the verification module stored on memory (e.g. any non-transitory computer readable memory). The verification module is configured to receive a time input from a user (e.g. via a keyed input of time using a user interface) and output the code corresponding to the time input. Rather than the current time, the time input is a historical (past) time. To do this, the verification module runs an algorithm (i.e. a verification algorithm) that uses the same correlation of time and code value as is used by the algorithm of the token. Thus given a historical time input, the verification module returns, as an output, the same code that the token produced at that time.

The verification module, or verification algorithm thereof, can optionally be configured to consider one or more variables before calculating a corresponding time, e.g. by passing variables (other than time input) through the validation algorithm. The validation algorithm can receive such variables directly, or by referencing a table, e.g. a table filled manually by an administrator or filled by the validation module or a registration module (e.g. upon asking the user questions of token ID, time zone, etc. at registration or at the time of receiving a user time input). Optional variables include: Token identifier (e.g. if the validation module is configured to validate codes for different tokens), Secret key (e.g. which combines with the algorithm equation to provide the time-code correlation when passed through the algorithm, Token Drift (e.g. a time shift applied to a user's time input), Time Zone Correction (e.g. to allow a user to enter a historical time in the user's local time format), and Daylight Savings Correction (e.g. subtracting one hour from user's time input if user's local time zone observes daylight savings shifts), e.g. as depicted in FIG. 15. By example, the token ID is not passed through the equation of validation algorithm for code calculation itself, but is used to identify a respective set of variables (the other variables listed) that are passed through the validation algorithm to calculate the code, e.g. a variable set comprising one or more of Secret Key, Token Drift, Time Zone Correction for Code Request, the answer to whether to Apply Daylight Savings.

Optionally, the verification module is configured to receive a user's one or more time inputs via keyed entry, uploaded list, or selection from a drop down menu. Further, the time input can be a specific time (e.g. 10:25 PM) or a time range (e.g. Mar. 25, 2017 or week 4 of March 2017).

Optionally, the verification module is configured to receive a user's time input in different time formats (e.g. different time zones), e.g. different time zones received from the same user or respective time zones received from different users or tokens, and is configured to apply a time shift correction to account for the time zone of the user's time input before calculating the corresponding code output, e.g. as the “Time Zone Correction” variable in FIG. 15. Optionally, the time format is designated by the user (e.g. via dropdown menu) when the user submits a request for corresponding code, or the time format is associated with the user at the time of registration (e.g. designated by user input during registration of the user's account or token).

A token's clock may drift over time. Thus, the verification module is optionally configured to apply a time shift to the user's time input before calculating the corresponding output code, e.g. as the “Token Drift” variable in FIG. 15. Optionally, the shift value applied to account for taken drift is created by a synchronization module (e.g. as described herein or in a following example).

Optionally, the verification module is configured to obtain a token ID, for example, to identify the correct set of variables for the validation algorithm. Optionally, the token identifier is keyed in by the user, or selected from a drop down box of a selectable token identifiers (e.g. if the user has multiple tokens). As displayed to the user, token identifiers can optionally be provided in the form of serial numbers or keywords (e.g. Building ID, Site ID or Room ID).

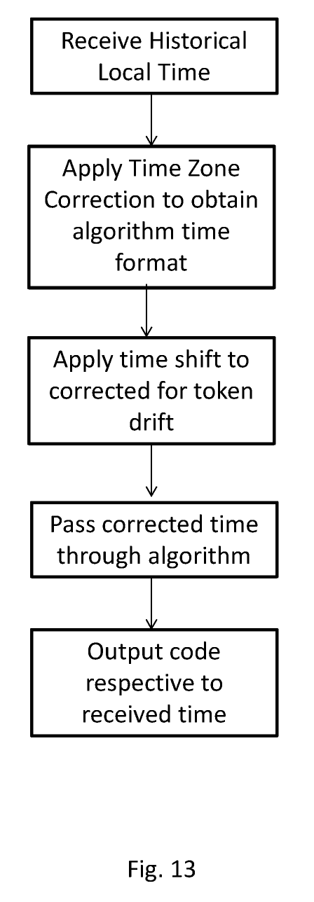

FIG. 13 depicts a flow chart of an optional method can be performed by a validation module, including optional steps of applying a time zone correction and token clock drift correction.

### Example 5 Verification of Codes Using a Validation Module

A user records one or more codes from a token, e.g. as detailed in Example 3. The token user's employer (a user of the server) obtains the record of codes and uses a validation module of a server to input one more of the recorded codes, e.g. the server detailed in Example 4. By example, the user interacts with the validation module as follows.

The validation module (or interface thereof) has one more methods to select a specific token. The user can key-in serial number or other Token ID; the user can select from a drop down or table that displays all of the user's registered token IDS; and/or the user can select or search for a Building ID, Site ID or Room ID that has been previously associated with one or more token IDs.

Upon selection of the desired token, the validation module (or interface thereof) displays one or more of the following information: Token ID, Building ID, Site ID, Building ID, Room ID, and Time Zone (e.g. by keyword or relative to UTC (−12 to +14)).

The validation module (or interface thereof) is further configured to allow the user to select or enter a time, for example, by keying in a time (which can be given calendar date) and/or selecting the time (or date) from a calendar display and selection menu.

In this illustrative example, the update interval of the token is 24 hours, and the intervals update at midnight (00:00) Coordinated Universal Time (UTC). However, in this illustrative example, the user has input a time by the selection of a date (Mar. 25, 2017) in time zone −10 (offset from UTC by −10 hours). Thus, the user's selected date (24 hour period) overlaps with two different dates defined by UTC. Accordingly, with a single time input, the validation module outputs two dates.

For example, the input of Mar. 25, 2017, time zone −10, provides the following code outputs:

Time: 00:00-10:00; Code; 2938

Time: 10:00-24:00; Code: 3429

The validation module (or interface thereof) can optionally be configured to save the output codes on a storage device local to the user, print the output codes on a printer local to the user, and/or display the output codes on a display local to the user.

The user of the validation module can then compare the output code(s) to the recorded list of output codes that was recorded by the token user to verify that the token user visited the token (and corresponding site) at the time required by the user's employer.

### Example 6 System of a Token, a Server Running a Verification Module and a Synchronization Module

A system of the invention optionally comprises a token, a server running a verification module configured to receive an input comprising a time value (or code value), pass the input time value or the input code value through a validation algorithm that uses the same code-time correlation as the token, and output the corresponding code value (or time value), for example, as detailed in Example 4.

In the present example, the validation algorithm is configured to receive, as a variable, a time shift to apply to the input time to correct for any clock drift of the token (e.g. as detailed in Example 4) such as by referencing a table that defines the time shift due to token drift (e.g. as shown in FIG. 15). This token time drift can optionally be calculated and provided by a synchronization module comprised by the server (or another server networked with the server).

The synchronization module is configured to:
a. receive an input of the token's current time,
b. compare token time to a comparator clock (e.g. a clock provided by a network time protocol (NTP) server),
c. determine a time shift between token time and comparator clock (i.e. due to token drift), and
d. send the determined time shift to the validation module (e.g. for recording and future use as a token drift variable, e.g. as in FIG. 15).

The input of the token's time can occur, for example, by user input (e.g. a user looking at a time displayed on the token), or a transmission of the tokens time to the synchronization module (e.g. by wireless transmission to a mobile device, such as by Bluetooth or NFC). Thus, the system can include a mobile device networked with the server (or the server can be a mobile device) such that a user can position the mobile device in front of the token and obtain the time displayed by the token.

In order to provide a precise input of the tokens time, the synchronization module (or interface thereof) can be configured to instruct the user to enter the token's display time, and then wait until the token's displayed time changes (e.g. to the next minute, or to a succeeding minute) before the user performs an operation on the user interface to execute the process of synchronizing (i.e. executing the first step, step a., of the steps detailed above). Then, the synchronization module (or interface thereof), rather than using the time directly indicated by the user's input, uses a time offset (e.g. by a minute or two) later than the user's input time. Thus, in this embodiment, the synchronization module adds a minute (or other time offset) to the user's input time before comparing the time with the comparator clocks time.

If the user is interfacing the synchronization module through a remote terminal, the synchronization is optionally configured to determine transmission latency between the remote terminal and the server comprising the synchronization module (e.g. a ping test). The determined latency can be added the user's input time to provide the actual token click time and thereby provide a more accurate synchronization with a clock server (e.g. NTP server).

Optionally, the synchronization module is configured to determine whether the time shift between token time and comparator clock (i.e. the tokens drift) exceeds a threshold drift (e.g. an allowable token drift, e.g. a reference threshold stored for comparison) and output an alert, e.g. locally to the server, or sent by email (e.g. to an admin's email), or sent by transmission of the alert networked remote terminal (e.g. admin's remote terminal), or sent to the module of a system user (e.g. an admin's account module for interfacing with the system).

Optionally, steps a.-c. are repeated a plurality of times (e.g. over a period of time), and the synchronization module is configured to calculate rate of drift (e.g. rate of change of drift over a period of time), AKA, a drift speed. Additionally or alternatively, the synchronization module is configured to calculate the rate of change of the drift rate (e.g. rate of change of drift speed over a period of time), AKA, a drift acceleration. In such embodiments, an alert (as described in the preceding paragraph) can also be sent when the synchronization module determines the drift speed or drift acceleration exceeds a threshold drift speed or drift acceleration.

Optionally, upon calculation of the drift speed or drift acceleration, the synchronization module is configured to is configured to send the drift speed or drift acceleration to the verification module and the system (e.g. the verification module or synchronization module) is configured to update the token drift variable (e.g. in FIG. 15) periodically in accordance with drift speed or drift acceleration (e.g. even in the absence of a future drift calculation from an input token time). Thus, the system can optionally use the drift speed or drift acceleration to predict the future tokens drift, even in the absence of a direct drift calculation from the input of a tokens current time.

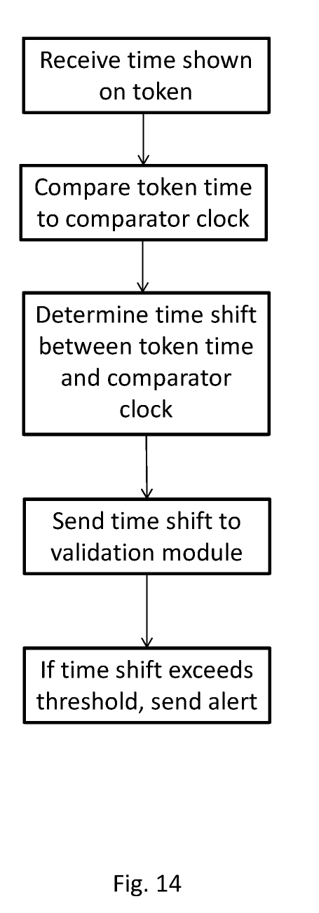

A flowchart of an example process carried out by the synchronization module is depicted in FIG. 14

### Example 7 Synchronization Process

In this example, a system having a token and a server comprising a synchronization module, e.g. as detailed in Example 6) is used to synchronize a validation algorithm to account for clock drift of the token.

The synchronization module (or interface thereof) is operated by a user. The system can optionally inform the user that this user's module is configured for measuring the clock drift of token and that the clock drift data will be used to accurately calculate the difference between a token's clock and a clock server's (e.g. NTP servers) time, and optionally that the token clock drift may be used to determine if the unit or battery is failing and if a replacement should be sent to the user.

The steps carried out by the synchronization module include:
1. Optionally prompt user to enter token ID;
2. Optionally prompt use to enter date displayed on the token;
3. Prompt user to enter the time (hh:mm);
4. Prompt user to wait until the minute displayed by the token changes (e.g. to the next minute) and then press an user interface command (e.g. “sync” button);
5. Add, to user's the time input, the period of time corresponding to the wait time, to provide a token time;
6. Compare the token time with a comparator clock to determine token clock drift; and
7. Save the token clock drift in a database (e.g. as in FIG. 15) accessed by the validation algorithm.

### Example 8 Systems Comprising a Network of Computers

While a system of the invention comprising a server (e.g. having a validation module and a synchronization module) can optionally be carried out on a single server that is accessed locally by users, the present invention also contemplates a system comprising a network of a server comprising a validation module and optionally a synchronization module, and further comprising one or more remote terminals.

The remote terminals can comprise one or more interface modules for allowing a user to interface with (i.e. use) the module(s) of the server. The interface module(s) of the remote terminals can be configured to provide any steps of displaying information to the user or prompting the user for inputs and receiving the inputs.

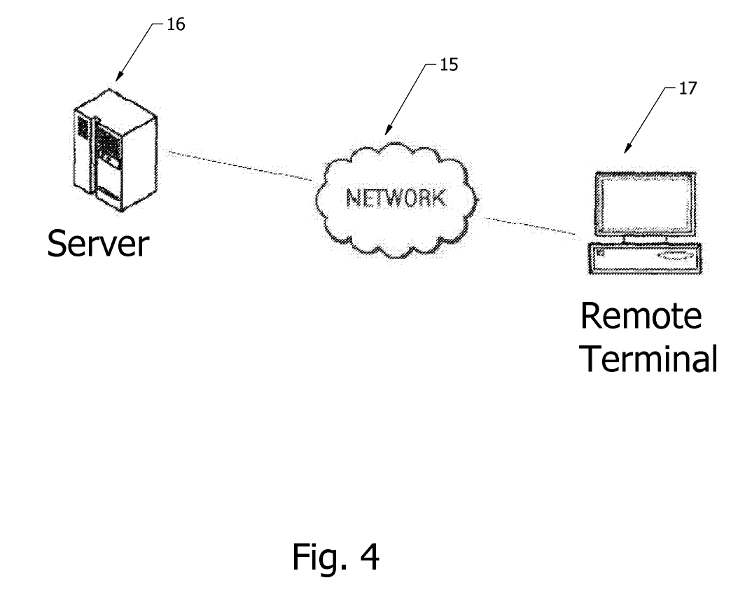

As shown in FIG. 4, the system can comprise a network 15 comprising a server 16 and a remote terminal 17. The server 16 can comprise a validation module and optionally a synchronization module (e.g. as detailed in herein or in the prior examples) and the remote terminal 17 can comprise a validation module interface and optionally a synchronization module interface for allowing a user to synchronize the validation module with the token clock.

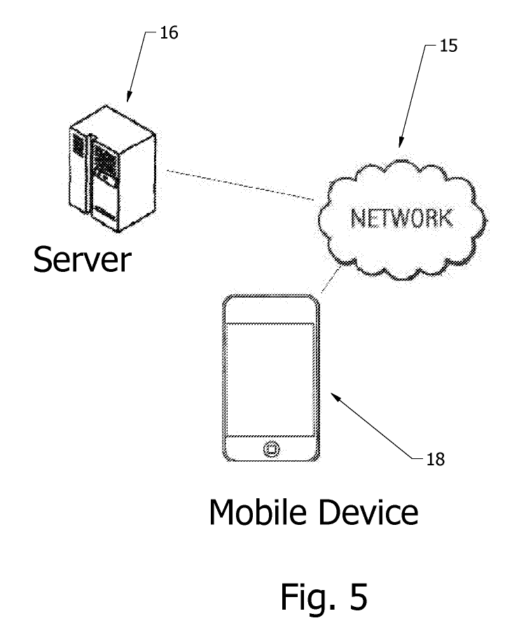

As shown in FIG. 5, the system can comprise a network 15 comprising a server 16 and a mobile device 18 as a remote terminal. The server 16 can comprise a validation module (e.g. accessed locally or remotely) and optionally a synchronization module (e.g. as detailed in herein or in the prior examples) and the mobile device 18 can comprise a synchronization module interface (or the entire synchronization module in addition to or rather than providing on the server) for allowing a user to synchronize the validation module with the token clock and/or a validation module interface.

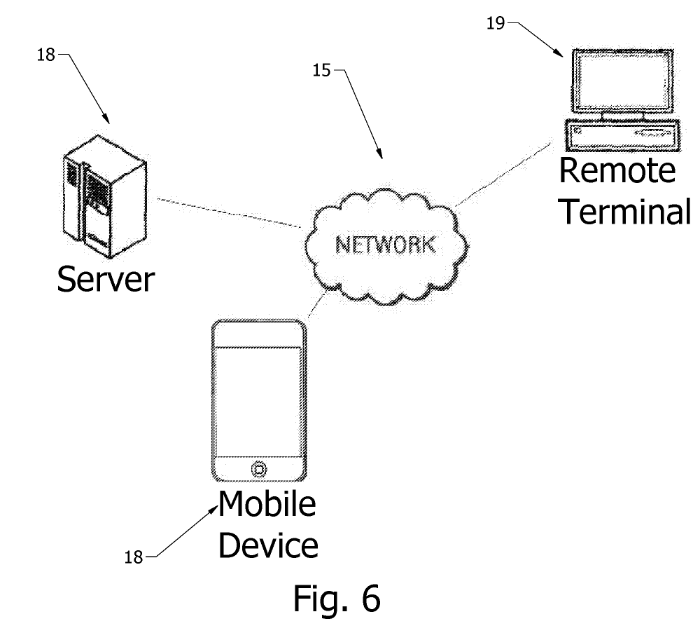

As shown in FIG. 6, the system can comprise a network 15 comprising a server 16, a mobile device 18 as a remote terminal, and a remote terminal 19. The server 16 can comprise a validation module (e.g. accessed locally or remotely) and optionally a synchronization module (e.g. as detailed in herein or in the prior examples) and the mobile device 18 can comprise a synchronization module interface (or the entire synchronization module in addition to or rather than providing on the server) and optionally a validation module interface for allowing a user to synchronize the validation module with the token clock. The remote terminal 19 can optionally comprise an administrative interface that allows changing data accessed by server modules (e.g. module variables shown in FIG. 15) and/or a synchronization module interface that allows the user of the remote terminal 19 to receive alerts (e.g. token drift alerts) from the synchronization module.

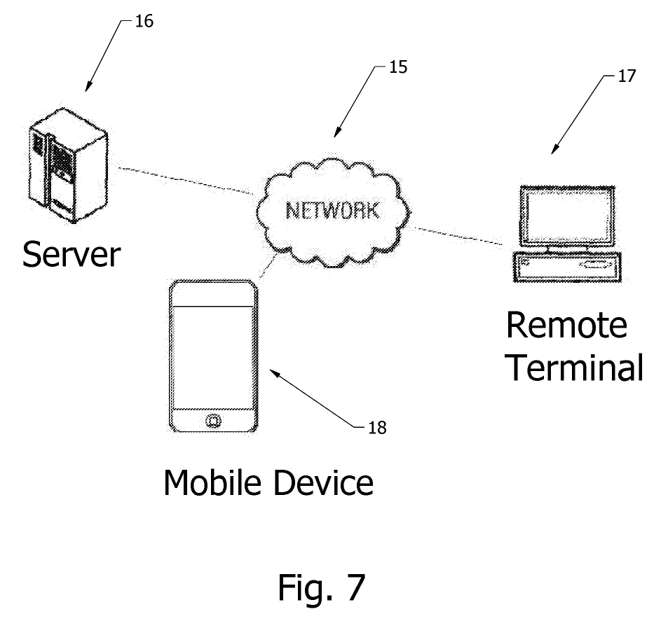

As shown in FIG. 7, the system can comprise a network 15 comprising a server 16, a remote terminal 17, and a mobile device 18 as a remote terminal. The server 16 can comprise a validation module and optionally a synchronization module (e.g. as detailed in herein or in the prior examples) and the remote terminal 17 can comprise validation module interface and optionally a synchronization module interface (or the entire synchronization module in addition to or rather than providing on the server) for allowing a user to synchronize the validation module. The mobile device 18 can comprise a synchronization module interface (or the entire synchronization module in addition to or rather than providing on the server) for allowing a user to synchronize the validation module and optionally a validation module interface. The remote terminal 17 and the mobile device 18 can optionally include modulus or interfaces assigned to the same user account (i.e. the user account has multiple remote terminals that can access the server modules).

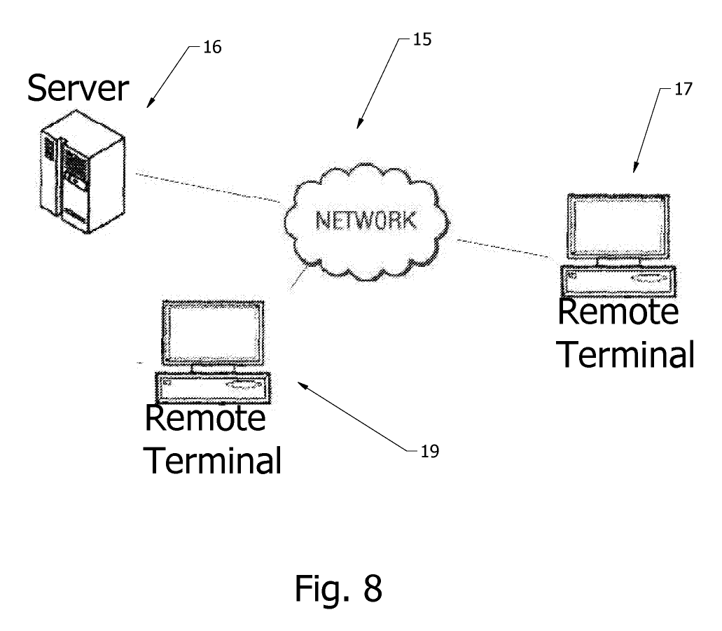

As shown in FIG. 8, the system can comprise a network 15 comprising a server 16, a remote terminal 17, and a remote terminal 19. The server 16 can comprise a validation module (e.g. accessed locally or remotely) and optionally a synchronization module (e.g. as detailed in herein or in the prior examples) and the remote terminal 17 can comprise a synchronization module interface (or the entire synchronization module in addition to or rather than providing on the server) and/or a validation module interface for allowing a user to synchronize the validation module with the token clock. The remote terminal 19 can optionally comprise an administrative interface that allows changing data accessed by server modules (e.g. module variables shown in FIG. 15) and/or a synchronization module interface that allows the user of the remote terminal 19 to receive alerts (e.g. token drift alerts) from the synchronization module.

In FIGS. 4-8, remote terminal 17 and mobile device 18 can optionally be considered as client terminals (i.e. users of tokens or employers of token users) and remote terminal 19 can optionally be considered an administrators (admin) terminal.

As shown in FIG. 12, the system can comprise a server having a validation module and a synchronization module, a remote terminal (client) having a validation module interface and a synchronization module interface), and a remote terminal (admin) having a server interface.

As shown FIG. 12, the validation module interface of the remote terminal (client) receives inputs locally to the remote terminal (e.g. via keyboard or other user interface or attached input devices) and sends these inputs to the validation module of the server. For example the validation module interface of the remote terminal (client) can receive an input of time or code (and optionally other inputs such as Token ID, time zone, etc.) and send the input to the validation module. The validation module of the server calculates the respective code (if input was time) or time (if input was code) using the validation algorithm and sends the resulting calculated respective time or code back to the validation module interface which then displays or otherwise outputs the calculated response to the user of the remote terminal (client).

As shown FIG. 12, the synchronization module interface of the remote terminal (client) receives an input locally to the remote terminal (e.g. via keyboard or other user interface or attached input devices) and sends the input to the synchronization module of the server. For example the synchronization module interface of the remote terminal (client) can receive an input of time (as shown by a nearby token) and send the input to the synchronization module of the server. The synchronization module of the server of the server receives the time input from the synchronization module interface, receives the time from a clock (e.g. networked clock server such as an NTP server), and compares the input time with the clock server time to determine any time shift due to token drift. The synchronization module then sends the determined time shift to the validation module (e.g. by updating a token drift variable table such as the table shown in FIG. 15).

As shown FIG. 12, the server interface of the remote terminal (admin) receives an alert from the synchronization module of the server, if the synchronization module determines that the token's drift exceeds a specified threshold. The server interface remote terminal (admin) can alert the admin user via display, email, or other output mechanisms.

Although not shown, other data can be transmitted between remote terminals and the server. For example, if the remote terminal (e.g. mobile device) is used to record token-displayed codes (e.g. by OCR using a camera, or keyed entry into the mobile device), the mobile device can send the recorded codes to the validation module, e.g. for use as a code input to the validation module or for comparison to code outputs of the validation module.

The citations provided herein are hereby incorporated by reference for the cited subject matter.

What is claimed is:

1. A token comprising:
a. a non-transitory computer-readable storage medium comprising a first algorithm that produces a code of characters from a clock time, wherein the value of the code characters produced is dependent upon a first correlation of time value and code character value;
b. a display; and
c. a controller configured to determine an instantaneous time value from a clock and execute the first algorithm based on the instantons clock time and cause the display to show the code produced by the first algorithm, wherein:
i. the characters of the shown code are sized to have a height of at least 0.65 cm; and
ii. the code comprises 2 to 7 characters; and
d. optionally, a mount configured to secure the token to a supportive structure.

2. The token of claim 1, wherein the mount comprises one or more eyelets configured to receive a screw.

3. The token of claim 1, wherein the update interval is 4 hours to 48 hours.

4. The token of the immediately preceding claim, wherein the update interval is 12 hours to 24 hours.

5. The token of claim 1, wherein the height is at least 0.8 cm.

6. The token of claim 1, wherein the code comprises 2 to 5 characters or 3 to 5 characters.

7. The token of claim 1, wherein the code comprises 4 characters.

8. The token of claim 1, wherein the controller is configured to cause the display to show information other than the code.

9. The token of claim 8, wherein the controller is configured to, when the other information is shown, cause the display to show a label of the information type simultaneously with the shown information.

10. The token of claim 8, wherein the controller is configured to show the other information on the display asynchronously with the code.

11. The token of claim 10, wherein the controller is configured to show the other information on a portion of the display that is different than a portion of the display on which the code is shown.

12. The token of claim 11, wherein the other information is selected from a current date and a token hardware identifier.

13. The token of claim 1, wherein:
a. the non-transitory storage medium comprising a second algorithm that produces a code of characters from a clock time, wherein the value of the code characters produced is dependent upon a second correlation of time value and code character value;
b. the controller is configured to execute the second algorithm and cause the display to show the code produced by the second algorithm;
c. the characters of the shown code produced by the second algorithm are sized to have a height of at least 0.65 cm; and
d. the code produced by the second algorithm comprises 2 to 5 characters; and
e. optionally, the code produced by the second algorithm comprises the same number of characters as the code produced by the first algorithm.

14. The token of claim 13, wherein the code produced by the first algorithm code and the code produced by the second algorithm are shown on different portions of the display.

15. The token of claim 13, wherein the controller is configured to asynchronously display the code produced by the first algorithm code and the code produced by the second algorithm are shown on different portions of the display.

16. The token of claim 15, wherein the controller is configured to prevent the showing of the code produced by the second algorithm for a specified period of time following display of the code produced by the first algorithm code.

17. The token of claim 13, wherein the duration of the update interval of the first algorithm code is the same as the duration of the update interval second algorithm.

18. The token of claim 1, wherein the display is selected from a liquid crystal display (LCD), a light emitting diode (LED) display, an organic light emitting diode (OLED) display, an electrophoretic (ePaper) display, and an electrochromic (EC) display.

19. The token of claim 1 wherein the token comprises a clock.

20. A system comprising:
a. a first token that produces a code from an algorithm that uses a first correlation of date and time, optionally wherein the token is a token of any previous claim; and
b. a server, wherein the server comprises:
i. a non-transitory computer readable medium (‘memory’) comprising:
1. a first validation algorithm that uses the first correlation to correlate code value and time value;
2. a validation module configured to;
a. receive an input comprising a time value or a code value;
b. pass the input time value or the input code value through the first validation algorithm, thereby determining a code value respective to the input time value or a time value respective to the input code value; and
c. output the determined code value or the determined time value to a user; and
ii. a controller configured to run the validation module.
